(19) United States
(12) Patent Application Publication
(10) Pub. No.: US 2024/0157234 A1
(43) Pub. Date: May 16, 2024

(54) STORAGE MEDIUM, INFORMATION PROCESSING SYSTEM, INFORMATION PROCESSING APPARATUS AND INFORMATION PROCESSING METHOD

(71) Applicant: NINTENDO CO., LTD., Kyoto (JP)

(72) Inventors: Yoshihiko ITO, Kyoto (JP); Takuto ASAKA, Kyoto (JP)

(21) Appl. No.: 18/508,652

(22) Filed: Nov. 14, 2023

(30) Foreign Application Priority Data
Nov. 14, 2022 (JP) 2022-181799

(51) Int. Cl. A63F 13/42; A63F 13/48; A63F 13/533; A63F 13/798

(52) U.S. Cl. CPC A63F 13/42; A63F 13/48; A63F 13/533; A63F 13/798

(57) ABSTRACT

An example information processing system starts a game in which at least one of game events to occur is randomly determined in response to a first instruction that is input by a player, and progresses the game based on an operation input by the player. The information processing system stores scenario data at least including game event information related to a game event that has occurred in the game started in response to the first instruction. The information processing system retrieves one of the stored scenario data that is specified based on an operation input by the player. The information processing system starts the game in which a game event to occur is determined based on the retrieved scenario data in response to a second instruction that is input by the player, and progresses the game based on an operation input by the player.

### CROSS REFERENCE TO RELATED APPLICATION

This application claims priority to Japanese Patent Application No. 2022-181799, filed on Nov. 14, 2022, the entire contents of which are incorporated herein by reference.

### FIELD

The present disclosure relates to a storage medium, an information processing system, an information processing apparatus and an information processing method for executing a game, wherein game events occur during the game.

### BACKGROUND AND SUMMARY

Conventionally, there are games that randomly determine the game settings, such as the characters used by the players in the game, the timing of changes of the characters used, and the mini-games executed in the game.

Where the game settings are randomly changed for every game, it is not possible for the player to intentionally play the game with the same settings.

Therefore, the present application discloses a storage medium, an information processing system, an information processing apparatus and an information processing method, with which the player can play the game again with desired game settings.

(1)

An example of one or more non-transitory computer-readable storage medium described herein stores instructions that, when executed, cause one or more processor of an information processing apparatus to execute game processing comprising: starting a game in which at least one of game events to occur is randomly determined in response to a first instruction that is input by a player; progressing the game started in response to the first instruction based on an operation input by the player; retrieving one of scenario data that is specified based on an operation input by the player, the scenario data at least including game event information related to a game event that has occurred in the game started in response to the first instruction; starting the game in which a game event to occur is determined based on the retrieved scenario data in response to a second instruction that is input by the player; and progressing the game started in response to the second instruction based on an operation input by the player.

With configuration (1) above, the player can play a game started in response to the second instruction with the same game settings (specifically, settings defined by the scenario data) as the game started in response to the first instruction. Thus, the player can play the game again with desired game settings.

(2)

In configuration (1) above, in retrieving the scenario data, the scenario data stored for the game started in response to the first instruction by the player may be retrieved based on an operation input by the player, and the scenario data stored for the game started in response to the first instruction by another player different from the player may be retrieved based on an operation input by the player.

With configuration (2) above, the player can retrieve scenario data for both of games that have been played by the player himself/herself and games that have been played by other players, and can play the game based on these scenario data.

(3)

In configuration (1) or (2) above, in retrieving the scenario data, the scenario data may be retrieved based on an operation input by the player from among the scenario data stored in response to the first instruction irrespective of whether the game has been cleared by the player.

With configuration (3) above, even if the player fails to clear the game started in response to the first instruction, the player can retry, by the second instruction, the game based on the scenario data of the game that the player failed to clear.

(4)

In any one of configurations (1) to (3) above, the game event information may include information related to a timing at which the game event occurs in the game.

With configuration (4) above, a timing at which a game event occurs can be controlled by the scenario data. Therefore, the player can play, as a game started in response to the second instruction, a game in which the game event occurs at the same timing as in the game started in response to the first instruction.

(5)

In any one of configurations (1) to (4) above, the game event information may include information related to an enemy character to appear in the game event.

With configuration (5) above, the contents of the game event in which an enemy character appears can be controlled by the scenario data. Therefore, the player can play, as a game started in response to the second instruction, a game in which the game event in which the enemy character appears is the same as in the game started in response to the first instruction.

(6)

In configuration (5) above, the game event information may include information related to a timing at which the enemy character appears in the game event.

With configuration (6) above, the timing at which an enemy character appears in a game event can be controlled by the scenario data. Therefore, the player can play, as a game started in response to the second instruction, a game in which the enemy character appears at the same timing as in the game started in response to the first instruction.

(7)

In configuration (5) or (6) above, the game event information may include information indicating a position at which the enemy character appears in a game stage in the game event.

With configuration (7) above, the position at which an enemy character appears in a game event can be controlled by the scenario data. Therefore, the player can play, as a game started in response to the second instruction, a game in which the enemy character appears at the same position as in the game started in response to the first instruction.

(8)

In any one of configurations (1) to (7) above, the game event information may include information indicating a game skill available to the player in the game.

With configuration (8) above, the skill available to the player in the game can be set by the scenario data. Therefore, the player can play, in a game started in response to the second instruction, a game in which the player uses the same skill as in the game started in response to the first instruction.

(9)

In configuration (8) above, the game process may further include presenting, to the player, at a scene for giving the first instruction or a scene therebefore, a candidate of the game skill made available in the game started in response to the first instruction.

With configuration (9) above, since the player can check the skill available in a game started in response to the first instruction before the start of the game, it is possible to improve the convenience for the player.

(10)

In any one of configurations (1) to (9) above, the scenario data may include information indicating a type of a game stage, from among a plurality of types of game stages, that is used in the game.

With configuration (10) above, the game stage to be used in the game can be set by the scenario data. Therefore, the player can play, in a game started in response to the second instruction, a game using the same game stage as in the game started in response to the first instruction.

(11)

In configuration (10) above, the game process may further include presenting, to the player, at a scene for giving the first instruction or a scene therebefore, a type of the game stage to be used in the game started in response to the first instruction.

With configuration (11) above, since the player can check the game stage to be used in a game started in response to the first instruction before the start of the game, it is possible to improve the convenience for the player.

(12)

In any one of configurations (1) to (11) above, the game event information may include information related to a range of movement of a player character across the game stage used in the game.

With configuration (12) above, the range of movement of the player character in the game can be set by the scenario data. Therefore, the player can play, in a game started in response to the second instruction, a game with the same range of movement as in the game started in response to the first instruction.

(13)

In any one of configurations (1) to (12) above, the scenario data may include information indicating a difficulty level of the game.

With configuration (13) above, the difficulty level in the game can be set by the scenario data. Therefore, the player can play, in a game started in response to the second instruction, a game with the same difficulty level as in the game started in response to the first instruction.

(14)

In configuration (13) above, the information indicating a difficulty level of the game included in the stored scenario data may be determined based on a parameter indicating a skill level that is associated with at least one of players participating in the game related to the scenario data.

With configuration (14) above, it is possible to execute a game with a difficulty level in accordance with the game skill of the participating players.

(15)

In any one of configurations (1) to (14) above, a game in which a plurality of players including the player who has given the first instruction participate may be started in response to the first instruction. A game in which a plurality of players including the player who has given the second instruction participate may be started in response to the second instruction.

With configuration (15) above, the player can play a game with the same game settings as in the game started in response to the first instruction, and with different participating players from the game started in response to the first instruction.

(16)

In any one of configurations (1) to (15) above, the scenario data may be generated each time the first instruction is given so that the game event randomly occurs in the game for each first instruction. The game based on the generated scenario data may be started in response to the first instruction. The scenario data generated in response to the first instruction may be stored for the game started in response to the first instruction.

With configuration (16) above, the same scenario data can be used for the game started in response to the first instruction and for the game started in response to the second instruction, it is possible to easily perform the game process using the scenario data.

(17)

In configuration (16) above, the scenario data may be generated based on player information that is associated with each player participating in the game started in response to the first instruction and that is based on previous game play of the player. The game event whose occurrence is determined based on the scenario data in the game started in response to the second instruction may be determined independent of the player information associated with the players participating in the game.

With configuration (17) above, the player can play a game with a scenario that the player cannot experience when playing a game started in response to the first instruction, by participating in a game that is started in response to the second instruction and that uses scenario data from a game in which the player himself/herself did not participate.

Note that the present specification discloses an information processing apparatus and an information processing system that execute processes of (1) to (17) above. The present specification also discloses an information processing method for executing processes of (1) to (17) above.

With the storage medium, the information processing system, the information processing apparatus or the information processing method described above, the player can play the game again with desired game settings.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a block diagram showing an example configuration in which a non-limiting game system shown in FIG. 1 is communicably connected to a non-limiting server;

FIG. 9 is a block diagram showing an example configuration of a non-limiting server;

FIG. 10 is a diagram showing an outline of a process to be executed in a non-limiting information processing system;

FIG. 11 is a diagram showing an example of a flow of a game executed in a non-limiting information processing system;

FIG. 12 is a diagram showing an example data structure of scenario data;

FIG. 13 is a diagram showing the relationship between various data included in scenario data and various elements of a scenario generated from the various data;

FIG. 14 is a diagram showing an example of a first start image displayed at the start of a random-scenario game;

FIG. 15 is a diagram showing an example of a scenario retrieval image displayed for retrieving scenario data;

FIG. 16 is a diagram showing a second start image displayed at the start of a scenario-specified game;

FIG. 17 is a diagram showing an example of a scenario selection image;

FIG. 18 is a diagram showing an example of various data stored in a server of a non-limiting information processing system;

FIG. 19 is a flow chart showing an example of a flow of a random-scenario game process executed by a non-limiting game system;

FIG. 20 is a flow chart showing an example of a flow of a first retrieval process executed by a non-limiting game system;

FIG. 21 is a flow chart showing an example of a flow of a second retrieval process executed by a non-limiting game system;

FIG. 22 is a flow chart showing an example of a flow of a scenario-specified game process executed by a non-limiting game system; and

FIG. 23 is a flow chart showing an example of a flow of a server process executed by a non-limiting server.

### DETAILED DESCRIPTION OF NON-LIMITING EXAMPLE EMBODIMENTS

[I. Configuration of Game System]

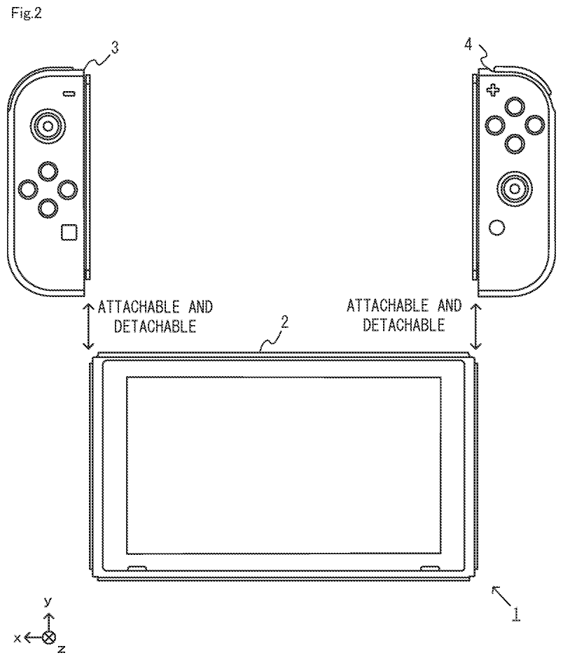

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

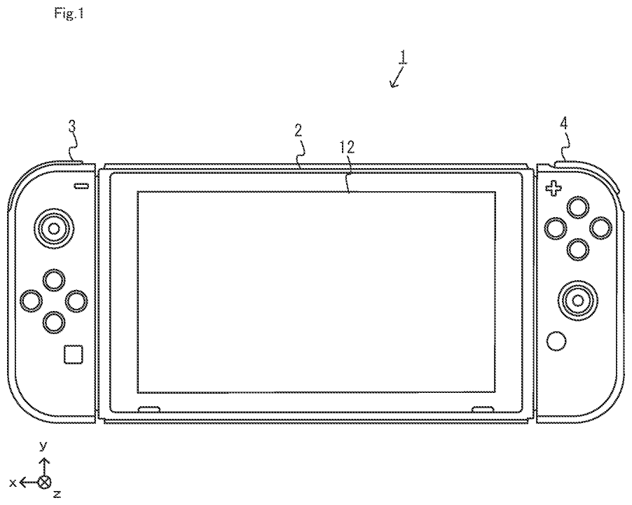

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

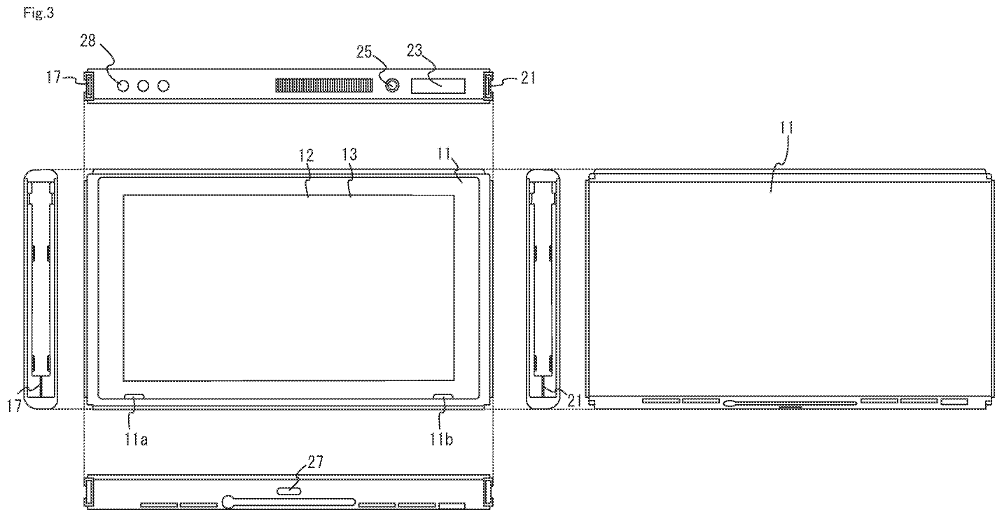

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

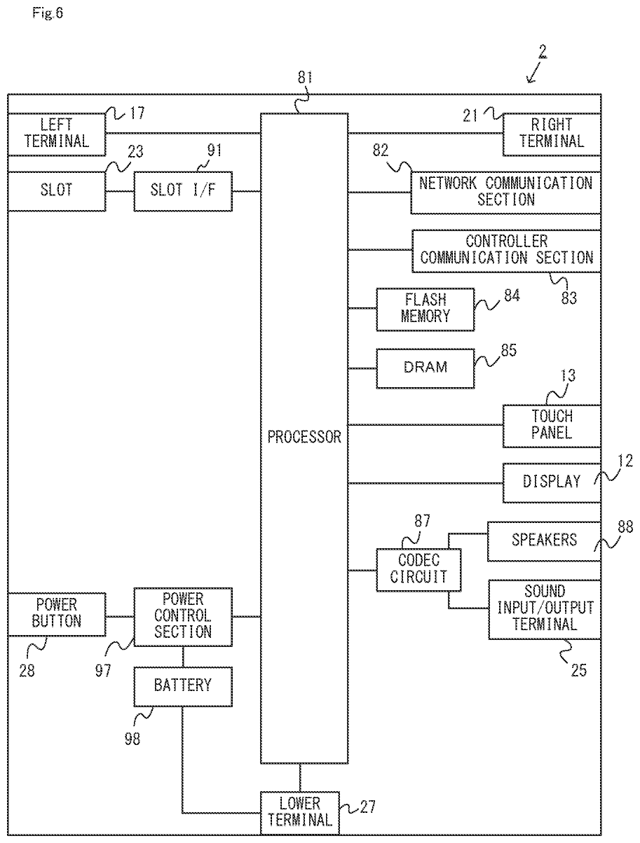

The main body apparatus 2 includes speakers (i.e., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and output from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

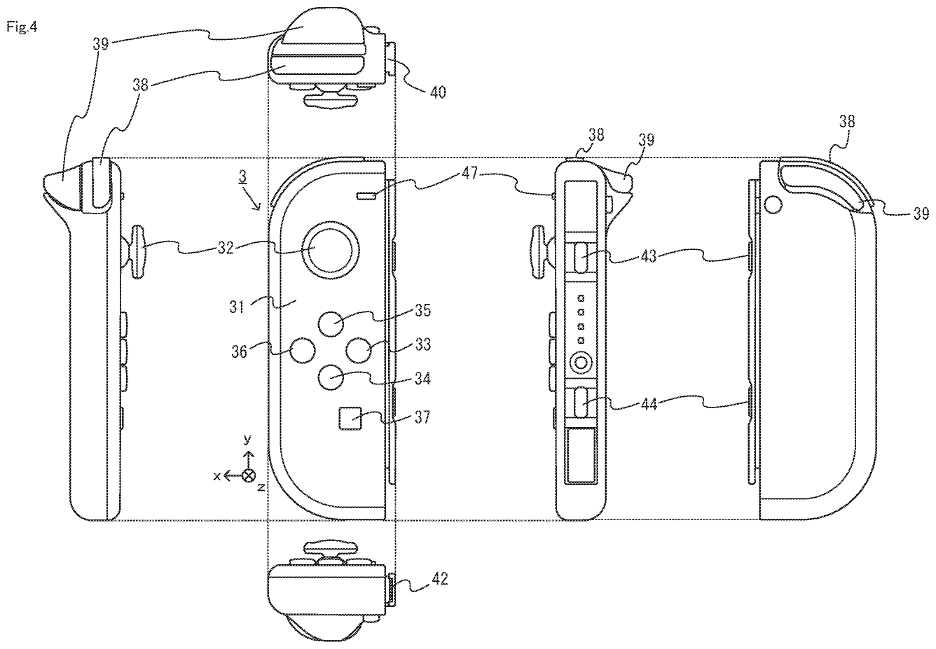

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction (i.e., a y-axis direction shown in FIGS. 1 and 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

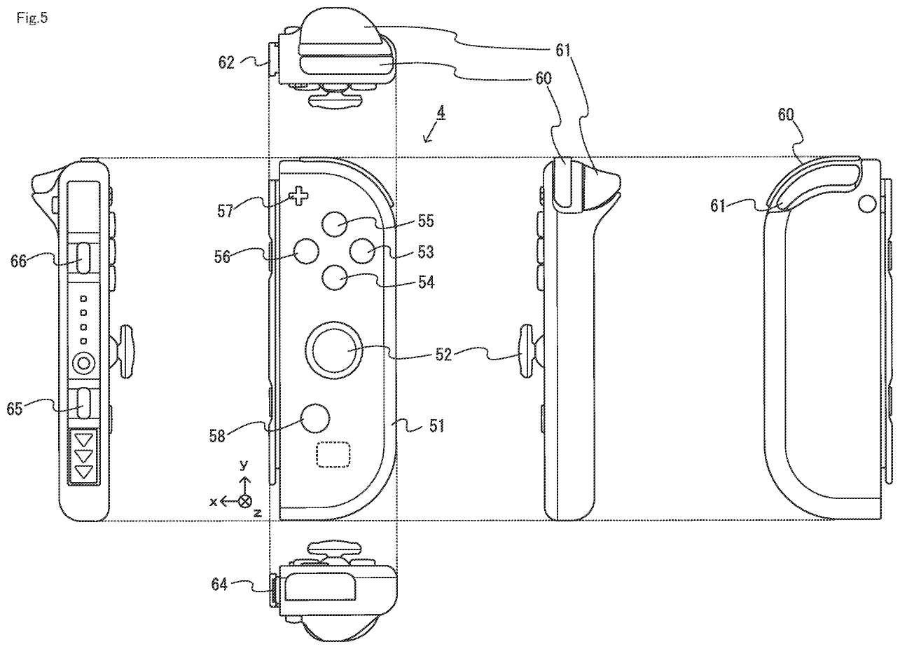

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as “I/F”) 91. The slot OF 91 is connected to the processor 81. The slot OF 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

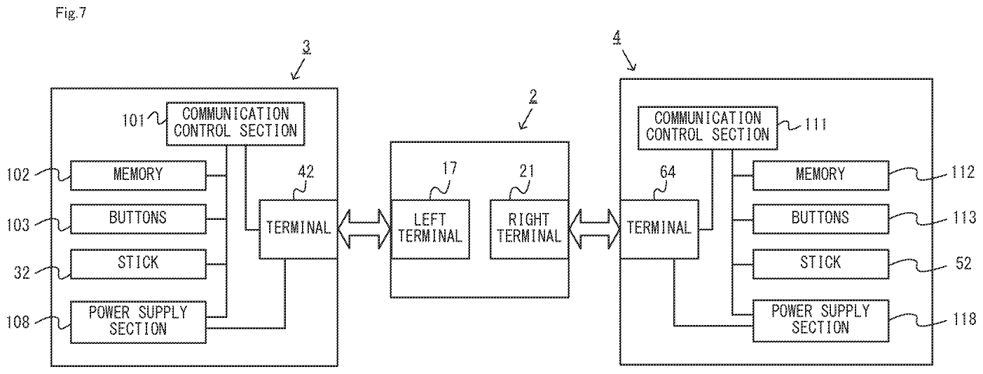

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

[2. Configuration of Information Processing System]

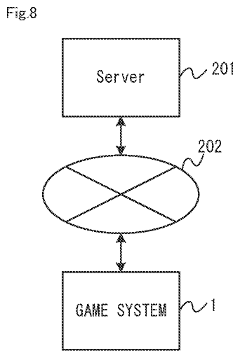

FIG. 8 is a block diagram showing an example of a configuration of an information processing system including the game system shown in FIG. 1. As shown in FIG. 8, the information processing system of the present embodiment is the game system 1 described above and includes multiple game systems used by different users (in FIG. 8, only one game system 1 is shown as an example). Note that the plurality of game systems included in the information processing system may include a different type of an information processing apparatus than the game system 1.

As shown in FIG. 8, the information processing system includes a server 201 that can communicate with the game systems. In the present embodiment, the game system 1 and the server 201 can be connected to a network 202 such as the Internet and/or a mobile communication network. The game system 1 and the server 201 can communicate with each other via the network 202. The game systems can communicate with each other via the network 202.

The term “server” as used herein refers to one information processing apparatus (i.e., a server device) and may also mean the entirety of a group of server devices (i.e., a server system) when the function of the server is realized by multiple server devices. That is, a “server” may be a server device or a server system. Note that when a server system includes multiple information processing apparatuses, each information processing apparatus may be arranged in the same location or in different locations. Note that the hardware configuration of the server 201 in the present embodiment may be the same as the hardware configuration for a conventional server.

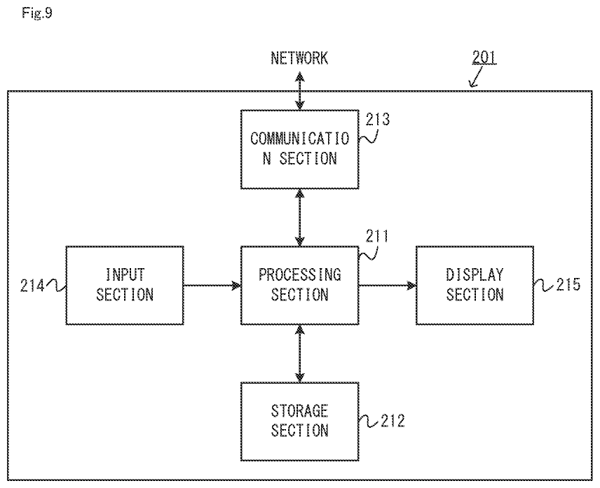

FIG. 9 is a block diagram showing an example configuration of the server 201. Each of the configurations included by the server 201 shown in FIG. 9 is realized by one or more information processing apparatuses. As shown in FIG. 9, the server 201 includes a processing section 211 and a storage section 212. The processing section 211 is electrically connected to the various sections 12 to 15 of the server 201. The processing section 211 includes a CPU (Central Processing Unit, in other words, a processor) and a memory. In the server 201, various types of information processes are executed by the CPU using the memory to execute programs stored in the storage section 212. The storage section 212 may be any storage device (also called a storage medium) that is accessible by the processing section 211. The storage section 212 stores programs executed by the processing section 211, data used for information processes by the processing section 211, and data obtained by the information processes, etc. In the present embodiment, the storage section 212 at least stores programs for the game processes executed on the server side for game processes executed in the game system 1.

The server 201 includes a communication section 213. The communication section 213 is connected to the network 202 and functions to communicate with other devices (e.g., the game system 1) via the network 202. The processing section 211 uses the communication section 213 to send information to and receive information from the other devices. The server 201 also includes an input section 214 and a display section 215 as input/output interfaces.

[3. Outline of Process in Information Processing System]

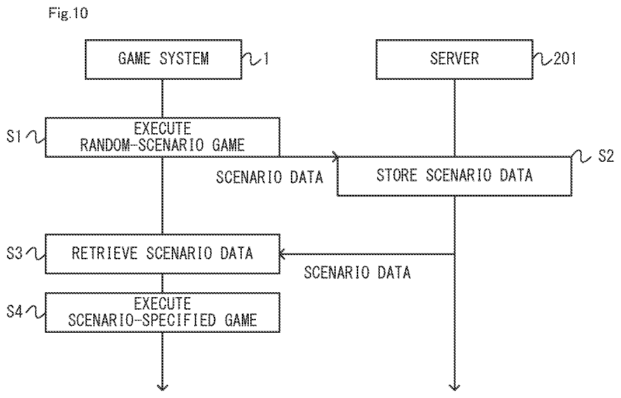

Next, referring to FIG. 10 to FIG. 17, an outline of processes to be executed in the information processing system will be described. In the present embodiment, the game system 1 executes a game in which a player character controlled by a player appears in the game space, which is a virtual space. Note that the game in the present embodiment is a game in which multiple players (here, four players), who are users of game systems, participate in the game, and the players cooperate together to satisfy the clear conditions of the game. Note that in other embodiments, the number of players who can participate in the game may be any number, and the game may be a game in which only one player participates. If multiple players can participate in the game, the game may be a type of a game in which the players cooperate together, or a type of a game in which the players play against each other.

FIG. 10 is a diagram showing an outline of a process to be executed in a non-limiting information processing system. In the present embodiment, the information processing system can execute two types of games, i.e., a random-scenario game and a scenario-specified game. The player can start a game by specifying which game the player wants to play, the random-scenario game or the scenario-specified game.

In the example shown in FIG. 10, the game system 1 executes a random-scenario game in response to an instruction by the player (step S1). A random-scenario game is a game in which at least a part of the scenario in the game is set at random. The scenario is the game settings related to the progress of the game (meaning to include the conditions for ending the game). As described in detail below, game events to occur during the game, game clear conditions, game difficulty levels, game stages, etc., are managed as the scenario.

In the present embodiment, after the random-scenario game is ended, scenario data for identifying the scenario in the random-scenario game is transmitted from the game system 1 to the server 201 and stored in the server 201 (step S2).

In the present embodiment, the game system 1 retrieves the scenario data stored in the server 201 (step S3). As described in detail below, in the present embodiment, the player can retrieve scenario data related to a random-scenario game that has been played by the player himself/herself as well as scenario data related to a random-scenario game that has been played by another player.

The game system 1 executes a scenario-specified game using the retrieved scenario data (step S4). A scenario-specified game is a game that is played in a scenario specified by the player (i.e., based on the scenario data specified by the player). Therefore, in the present embodiment, the player can play the game (specifically, a scenario-specified game) again with the scenario by retrieving the scenario data related to the scenario in the random-scenario game. According to this, for example, the player can repeatedly play a game with the same scenario.

[3-1. Outline of Game]

First, an outline of the game executed in the present embodiment will be described. The game in the present embodiment (i.e., a random-scenario game or a scenario-specified game) is a game in which the player character collects items that can be obtained by defeating enemy characters that appear in the game stage. Specifically, the player controls the player character to defeat enemy characters that appear in the game stage, and carries the items that can be obtained when defeating a predetermined enemy character to a predetermined location in the game stage. Then, the player can clear the game by collecting a specified number (called the clear condition number) of items at the specified location within a time limit. Note that the specific contents of the game are arbitrary, and in other embodiments, the game is not limited to the above game contents.

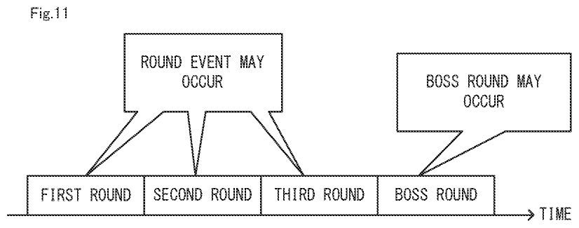

FIG. 11 shows an example of a flow of a game executed in an information processing system. In the present embodiment, a game consisting of one or more rounds is executed in response to a single game start instruction by the player. As shown in FIG. 11, in the present embodiment, in one iteration of the game (i.e., a game started in response to a single game start instruction), three normal rounds from the first to third rounds can be executed. In one iteration of a normal round, a player can clear the normal round of the game by collecting a number of items equal to or greater than the clear condition number within the time limit. On the other hand, if the player fails to collect a number of items equal to or greater than the clear condition number within the time limit, or if all the player characters are in a predetermined state (e.g., unable to attack or unable to act) due to, for example, being attacked by an enemy character beyond a certain level or falling into a water area as described below, the game ends in failure for the normal round.

If the first round is cleared, the second round of the game starts. On the other hand, if the first round is not cleared, the one iteration of the game ends, without executing the second and subsequent rounds of the game. Similarly, if the second round is cleared, the third round of the game starts, and if the second round is not cleared, the one iteration of the game ends, without executing the third and subsequent rounds of the game.

In the present embodiment, if the third round is cleared, a boss round of the game different from the normal rounds may be executed after the third round (see FIG. 11). Note that in a random-scenario game, the boss round is not always executed, and one iteration of the game may end when the third round ends. The boss round of the game is a game in which a predetermined boss character (e.g., an enemy character that does not appear in the first to third rounds) appears. Note that the condition under which the boss round game is executed will be described below. The clear conditions for the boss round are different from those of the first to third rounds, i.e., the game is cleared when the boss character is defeated. On the other hand, if a player fails to defeat the boss character within a predetermined time limit, or if all player characters are in the predetermined state described above, the game ends in failure for the boss round. Note that one iteration of the game ends as the boss round ends.

In the present embodiment, round events may occur in the first to third rounds (see FIG. 11). A round event is a game event that causes a different game situation than normal (i.e., where no round event occurs) in a round. In a random-scenario game, round events occur randomly. While the contents of the round event are arbitrary, for example, the round event may be an event in which a different enemy character appears than normal, more enemy characters appear than normal, or a change occurs to the game stage. Note that the change occurring to the game stage is, for example, fog covering the game stage to reduce visibility, or objects being arranged in the game stage to attack enemy characters. The conditions under which round events occur in the first to third round will be described below.

In the present embodiment, the player character may use weapons in the game. In the present embodiment, the candidates (specifically, four candidates) of weapons that can be used by the four player characters participating in a single iteration of the game are set before the game starts, and the weapon to be used by each player character is determined for each round from among the candidates. Note that the method of determining the candidates of weapons, and the method of determining the weapons to be used by the player characters in each round will be described below.

In the present embodiment, the game stage in the game are set before the game starts. In the present embodiment, a plurality of game stages are prepared, and one game stage to be used in the game is set before the game starts from among the plurality of game stages. Note that the method of determining the game stage in the game will be described below.

In the present embodiment, the game stage has an area of water that the player character cannot enter, and the water level can change from one round to another in one iteration of the game. In the present embodiment, the water level is set to one of three levels: low water level, medium water level and high water level. Note that the game stage includes areas of different heights, including an area that is above the water level only when the water level is low, an area that is above the water level when the water level is low or medium, and an area that is above the water level regardless of the water level. As described above, in the present embodiment, the movable range of the player character changes as the water level changes. For example, where the movable range changes, the movable range may become narrower when the water level is high, causing enemy characters to appear densely in a narrow area, or the movable range may become wider when the water level is low, causing the player character to have to travel a longer distance to reach a predetermined location to collect the item after defeating an enemy character, thereby changing the playability. Note that the conditions under which the water level changes will be described below.

As described above, in the game of the present embodiment, various elements in the game can change from one game to another. In the present embodiment, the information processing system manages these elements as a scenario of the game. In the present embodiment, the information managed as a scenario (which can also be called elements of a scenario) includes the following information.
information regarding clear conditions
information regarding round events
information regarding occurrence of boss round
information regarding enemy characters
information regarding player characters
information regarding game stage

Information regarding clear conditions is, for example, information indicating clear conditions for each round, specifically, the number of the items to be collected to clear the game (i.e., the clear condition number), etc. Note that in other embodiments, information regarding clear conditions may include information indicating the time limit for each round and information indicating conditions for failing in the game.

Information regarding round events is, for example, information indicating whether or not a round event occurs, the type of round event that occurs, and the timing at which a round event occurs (i.e., the round in which the round event occurs). Note that in other embodiments, the information regarding round events may include information regarding the reward that can be obtained if the round in which the round event occurs is cleared.

Information regarding occurrence of boss round is, for example, information regarding whether or not the boss round is executed, information of the timing at which the boss character appears, etc. Note that in other embodiments, information regarding occurrence of boss round may include information indicating the type of boss round to be executed (where multiple types of boss rounds are prepared), information indicating the ability (also called strength) of the boss character that appears, and information regarding the reward that can be obtained when the boss character is defeated.

Information regarding enemy characters includes, for example, information regarding the number of enemy characters that appear (more specifically, the total number of enemy characters that can appear simultaneously, the maximum number of enemy characters that can appear in one round), the timing at which enemy characters appear, and the location at which enemy characters appear. Note that in other embodiments, the information regarding enemy characters may include information indicating the ability (also called strength) of the enemy characters that appear, and information regarding the rewards that can be obtained when the enemy characters are defeated.

Information regarding player characters includes, for example, candidates of weapons that can be used by player characters and information regarding weapons used by player characters for each round. Note that since the ability of a player character varies depending on the weapon used, it can be said that weapons used by player characters being different from each other means that skills available to the player characters are different from each other. Information regarding player characters may be information regarding skills available to the player characters. Note that the number of weapons that can be used simultaneously by a player character is not limited to one, and the player character may be allowed to use multiple types of weapons (e.g., a main weapon and a sub-weapon) simultaneously. In this case, all of the multiple types of weapons may be determined by the scenario, or only some of them may be determined by the scenario with the others being freely selected by the player character.

Information regarding game stage is, for example, information regarding the type of game stage used in the game, the water level for each round, etc. Note that in other embodiments, information regarding game stage may include information regarding items and objects arranged in the game stage, information regarding the weather of the game stage, etc.

[3-2. Scenario Data]

In the present embodiment, the information processing system generates scenario data to identify the scenario described above. At the start of the game, the scenario of the game is determined based on the generated scenario data.

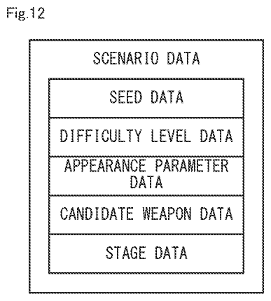

FIG. 12 shows an example data structure of generated scenario data. In the present embodiment, the scenario data includes seed data, difficulty level data, appearance parameter data, candidate weapon data, and stage data.

The seed data indicates a random number seed (i.e., a numerical value from which a sequence of random numbers is generated). As described in detail below, in the present embodiment, some of the elements included in the scenario (e.g., whether or not a round event occurs) are determined using random numbers. The seed data is data indicating a random number seed for generating random numbers (specifically, a sequence of random numbers). Note that the same random number sequence is generated for random number seeds that are of the same value. Therefore, where a lot is drawn using a random number sequence, for random number seeds that are of the same value, the lot is drawn using the same random number sequence, thereby producing the same draw result, whereas for random number seeds of different values, the lot is drawn using different random number sequences, thereby producing different draw results. As described in detail below, in the present embodiment, the information processing system determines the random number seed by performing the draw process at the timing of starting a random-scenario game. On the other hand, at the timing of starting a scenario-specified game, the draw process for determining the random number seed is not performed and the same random number seed as in the random-scenario game is used, so that the scenario-specified game can be played repeatedly with the same scenario as in the random-scenario game.

The difficulty level data indicates the difficulty level of the game. Some of the elements included in the scenario (e.g., information regarding enemy characters described above) are determined based on the difficulty level, as described in detail below.

The appearance parameter data is data of an appearance parameter that indicates the likeliness of the boss character appearing. In the present embodiment, the higher the value of the appearance parameter, the more likely a boss round will occur.

The candidate weapon data indicates candidate weapons that can be used by player characters in the game. In the present embodiment, the candidate weapon data indicates four different weapons to be used, one for each of four player characters.

The stage data indicates the type of game stage used in the game. As described above, there are multiple types of game stages in the present embodiment, and the stage data indicates one of the multiple types of game stages.

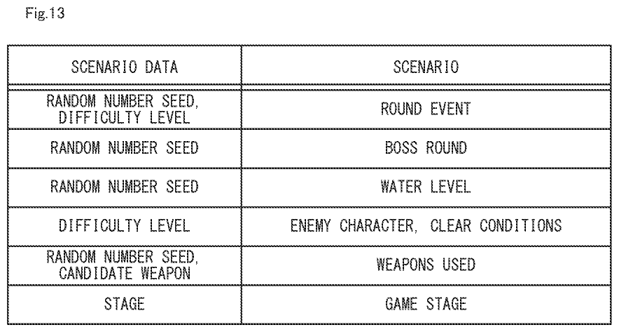

FIG. 13 is a diagram showing the relationship between various data included in scenario data and various elements of a scenario generated from the various data. As shown in FIG. 13, the elements related to a round event (specifically, whether or not a round event occurs, the type of round event that occurs, and the timing of the occurrence of the round event) are determined based on the random number seed indicated by the seed data and the difficulty level indicated by the difficulty level data. For example, the information processing system determines the elements related to the round event by drawing a lot for each round to determine whether or not a round event occurs and the type of round event that occurs, using random numbers generated from the random number seed. At this time, the information processing system draws a lot with a probability in accordance with the difficulty level. For example, the information processing system draws a lot so that a round event that is difficult to clear is more likely to be selected when the difficulty level is high, and a round event that is easy to clear is more likely to be selected when the difficulty level is low. In the present embodiment, the information processing system stores a table that maps the difficulty level to the occurrence of round events and the types of round events that occur, and determines the occurrence of a round event and the type of round event that occurs based on the table and the random number seed determined by the draw process.

The elements related to the boss round (which may specifically include whether or not a boss round is executed, and the timing of the boss character appearing) are determined based on the random number seed indicated by the seed data and the appearance parameter indicated by the appearance parameter data. Specifically, whether or not to execute the boss round is determined by drawing a lot using random numbers generated from a random number seed so that the boss round is executed with a probability that is in accordance with the value of the appearance parameter (i.e., the larger the value, the higher the probability). For example, the information processing system stores a table that maps appearance parameters to whether or not the boss round is executed, and determines whether or not the boss round is executed based on the table and the random number seed determined by the draw process. Note that where the boss round is executed, the information processing system may determine the timing of the boss character appearing (i.e., the amount of time since the start of the boss round until the boss character appears) by drawing a lot using the random numbers.

The water level for each round is determined based on the random number seed indicated by the seed data. Specifically, the water level is determined using a random number generated from the random number seed. More specifically, the information processing system determines the water level, from among low water level, medium water level and high water level, for each round by drawing a lot for each round using random numbers. For example, the information processing system stores a table regarding water levels and determines the water level for each round based on the table and the random number seed determined by the draw process. Note that the draw probability for the water level may be 1:1:1, or a different draw probability may be pre-specified for each water level.

The elements related to enemy characters (specifically, the number, type and position of enemy characters to appear) are determined based on the difficulty level indicated by the difficulty level data. For example, the information processing system stores a table that maps patterns of the number of enemy character appearances and positions of appearance to difficulty levels, and determines the number of enemy character appearances and positions of appearance by identifying a pattern that is associated with the difficulty level indicated by the difficulty level data in the table.

The elements related to clear conditions (specifically, the clear condition number described above) are determined based on the difficulty level indicated by the difficulty level data. For example, the information processing system stores a table that maps the difficulty level to the clear condition number, and determines, as the clear condition number for the game, the clear condition number that is associated with the difficulty level indicated by the difficulty level data in the table.

Weapons to be used by player characters are determined based on the random number seed indicated by the seed data and the candidate weapons indicated by the candidate weapon data. Specifically, the information processing system determines the weapon to be used by each player character from among four candidate weapons based on the random number seed determined by the draw process. By performing the determination of the weapon to be used for each round, the weapon to be used by each player character for each round is determined. The information processing system determines weapons to be used by player characters for each round so that, for example, the player characters use different weapons in one round and so that each player character uses different weapons in different rounds.

The game stage used for the game is determined to be the type of game stage indicated by the stage data.

Note that the relationship between the scenario data and various elements of the scenario shown in FIG. 13 is an example, and the contents of the scenario data and the method of determining the various elements from the scenario data are arbitrary. In other embodiments, the scenario data may include data that directly indicates whether or not a round event or boss round occurs and information of the water level, instead of the seed data for identifying the draw results for various elements of the scenario and the corresponding table data. In other embodiments, the information processing system may also determine elements and game stages related to enemy characters and clear conditions based on a random number seed in order to ensure randomness.

As described above, in the present embodiment, various game events that occur in the game are determined based on the scenario data. In the present embodiment, in addition to the round event described above, executing a boss round, the appearance of an enemy character, a change in the water level, and a change in the weapon used by the player character can also be said to be examples of game events. In the present embodiment, the information processing system can generate scenario data that includes at least game event information related to game events, and execute a game based on the scenario data, thereby causing game events to occur in the game. Note that “game event information related to game events” may be information indicating the game event itself or may be information that is used to identify the game event (e.g., the random number seed described above).

As described above, in the present embodiment, the game event information includes information regarding the timing at which various game events occur in the game (specifically, seed data and difficulty level data used for identifying the timing at which a round event occurs and the timing at which a boss character or an enemy character appears). Thus, the timing at which game event occurs can be controlled by the scenario data.

The game event information also includes information regarding enemy characters that appear in the game event (specifically, seed data, difficulty level data and appearance parameter data that are used to identify information regarding the appearance of enemy characters or boss characters). More specifically, the game event information includes information regarding the timing at which enemy characters appear in game events (specifically, seed data that is used to identify the timing at which enemy characters appear). The game event information also includes information indicating the position at which an enemy character appears in a game stage in a game event (specifically, difficulty level data that is used to identify the position at which the enemy character appears). Thus, whether or not enemy characters appear in game events, as well as the timing and position of their appearance, etc., can be controlled using the scenario data.

The game event information also includes information indicating game skills (i.e., weapons that can be used by the player character) available to the player in the game. This information is specifically seed data and candidate weapon data for identifying the weapon used by the player character. Thus, skills available to the player in the game can be set by using the scenario data.

The game event information also includes information regarding the range of movement of the player character across the game stage used in the game (specifically, the seed data used to identify the water level). Thus, the range of movement of the player character in the game can be controlled by using the scenario data, and changes in playability due to changes in the range of movement can be controlled by using the scenario data.

The scenario data also includes information indicating the type of game stage used in the game (i.e., stage data) among the plurality of game stages. Thus, the game stage used in the game can be set by using the scenario data.

The scenario data also includes information indicating the difficulty level of the game (i.e., difficulty level data). Thus, the difficulty level of the game can be set by using the scenario data.

Note that the scenario data does not need to include all of the data shown in FIG. 12, and may also include data other than the data shown in FIG. 12. For example, if there are multiple types of games with different numbers of player participants and different candidate game stages used, the scenario data may include information used for identifying the type of game.

[3-3. Random-Scenario Game]

As described above, in the present embodiment, the information processing system is capable of executing a random-scenario game in which at least some of the elements of the scenario are randomly determined (step S1 shown in FIG. 10). The random-scenario game will now be described below.

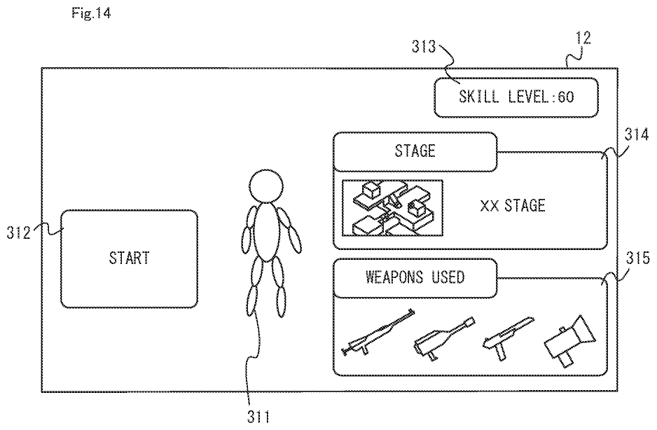

FIG. 14 shows an example of a game image (called the first start image) displayed at the start of a random-scenario game. The first start image is displayed on the display 12, for example, in response to an instruction to specify a random-scenario game in a scene where the player receives an instruction to specify the type of game to be played.

As shown in FIG. 14, the first start image includes a player character image 311 showing the player character controlled by the player. The first start image includes a start instruction image 312. The start instruction image 312 is an image used for giving a start instruction to the player to start the random-scenario game. That is, the player gives a start instruction by performing a predetermined determination operation while the start instruction image 312 is specified (e.g., the cursor, not shown, is specifying the start instruction image 312), and the random-scenario game is started in response to the start instruction.

The first start image includes a skill level image 313 indicating the skill level of the player for the game. The skill level is a parameter associated with each player, and the information processing system stores the skill level value for each player. In the present embodiment, the skill level is updated in accordance with the game results of the player. For example, the skill level may increase or decrease in accordance with the number of rounds cleared in the game, so that if the player has cleared through the third round, the skill level increases by a predetermined value, and if the player failed in the first round, the skill level decreases by a predetermined value. Note that the method of updating the skill level is arbitrary, and the skill level may be updated based on an index indicating the player's control skill in the game in addition to (or instead of) the game results. The skill level may be updated based only on the results of the random-scenario game, or may be updated based on the results of a game other than the random-scenario game (e.g., the scenario-specified game). In the present embodiment, the skill level is a numerical value (60 in the example shown in FIG. 14), but the skill level may be indicated by stages, such as level A and level B, or by a title attached to the player.

The first start image includes a stage image 314 showing the game stage used in the game. In the example shown in FIG. 14, the stage image 314 includes a thumbnail image of the game stage and the name of the game stage (i.e., “xx stage” in FIG. 14).

In the present embodiment, the game stage used in the random-scenario game is determined in accordance with the time of execution of the game. That is, the game stage used in the random-scenario game changes in accordance with the passage of time in the real world. For example, the game stage may be set so as to change each time a predetermined amount of time elapses. Specifically, the server 201 stores current stage data indicating the game stage used in the random-scenario game at the current time. The game system 1 retrieves the current stage data from the server 201 when displaying the first start image, and determines the contents of the stage image 314 based on the retrieved current stage data.

The first start image includes a candidate weapon image 315 showing the candidate weapons that player characters can use in the random-scenario game. In the example shown in FIG. 14, the candidate weapon image 315 includes images of four candidate weapons.

In the present embodiment, the candidate weapons that can be used by player characters in the random-scenario game are determined in accordance with the time of execution of the game, as with the game stage. The candidate weapons may be changed each time a predetermined amount of time elapses, for example. Specifically, the server 201 stores current candidate data indicating the candidate weapons that can be used in the random-scenario game at the current time. The game system 1 retrieves the current candidate data from the server 201 when displaying the first start image, and determines the contents of the candidate weapon image 315 based on the retrieved current candidate data.

As described above, in a scene where a start instruction to start a random-scenario game is given (i.e., a scene where the first start image is displayed), the information processing system presents, to the player, the type of game stage used in the random-scenario game and the game skill candidates (specifically, candidate weapons) that may be made available in the game. Thus, the player can check the game stage and the game skill candidates in the random-scenario game before the game starts, thereby improving the convenience for the player. For example, the player can start the random-scenario game after determining whether the game stage is one that the player is good at and whether the player can use a weapon that the player is good at. Note that the scene where this presentation is made is not limited to the scene for giving a start instruction, but may be an earlier scene (e.g., a scene that is immediately before the first start image is displayed). This can also achieve similar effects to those described above. In other embodiments, the information processing system may present only one of the game stage type and the game skill candidate. This may also improve player convenience. In other embodiments, the information processing system does not need to make this presentation before the start of the random-scenario game.

In response to the start instruction described above (i.e., the operation of specifying the start instruction image 312) while the first start image is displayed, the game system 1 executes the process to start the random-scenario game. Specifically, first, the game system 1 sends a matching request to the server 201 for matching with other players to participate in the random-scenario game. In response to the matching request, the server 201 determines other players to participate in the random-scenario game. For example, the server 201 determines other players to participate in the random-scenario game from among players of game systems, other than the game system 1, who have transmitted matching requests.

Once the players to participate in the random-scenario game are determined, the server 201 transmits the information of the players to participate in the random-scenario game to the game systems associated with the players. This means that each game system has retrieved information regarding players to participate in the game (and game systems used by the players), thereby enabling communication between the game systems. Note that once communication is enabled between the game systems, information may be exchanged directly between game systems directly or may be exchanged between game systems via the server 201.

When players to participate in the random-scenario game are determined, the game system to be the host system generates scenario data. Note that the method of setting the game system to be the host system is arbitrary and may be determined by any method. For example, among game systems associated with the participating players, the game system that has first transmitted the matching request may be set to be the host system. The scenario data may be generated by the server 201 or by a game system other than the host system.

In the present embodiment, scenario data for a random-scenario game is generated as follows. Note that it is assumed in the following that the game system 1 generates the scenario data.

For the seed data, the game system 1 determines values of random number seeds in such a way that the values will not be same (e.g., by a draw process). Here, different random number sequences are generated using different random number seed values. Therefore, in a random-scenario game, by setting a different value each time as the random number seed, the elements of the scenario determined based on each random number seed (i.e., using the random number sequence generated from the random number seed) will be randomly determined for each random-scenario game.

Note that “randomly determined” as used herein is not limited to the method in which determined results are selected with an equal probability, but also includes a determination method such as to produce random results (i.e., by a method such that the determined outcomes from multiple attempts will not be the same). For example, a random determination may be performed in such a way that a particular result is likely to occur under certain conditions (e.g., the higher the value of the appearance parameter, the more likely a boss round is to occur).

For difficulty level data, the game system 1 determines the difficulty level based on the skill level of each player participating in the random-scenario game. Specifically, the difficulty level is determined so that the higher the skill level of each player, the higher the difficulty level. For example, the difficulty level may be determined in accordance with the average value of the skill level of the players. In other embodiments, the game system 1 may use a random number in addition to the player's skill level to create a range of difficulty levels to be determined. Note that the difficulty level may be determined based on the skill level of at least one of the players participating in the random-scenario game. Thus, the information processing system can execute a game whose difficulty level is in accordance with the game skills of the participating players. Note that in other embodiments, the difficulty level may be determined based on information different from the skill levels of the participating players, e.g., it may be determined randomly.

For appearance parameter data, the game system 1 determines an appearance parameter based on the appearance determination parameter set for each player. In the present embodiment, the appearance determination parameter is calculated so as to increase as the player plays the game. Specifically, the appearance determination parameter may increase unconditionally when the game is played, or it may increase when certain conditions are met in the game (e.g., a specific enemy character is defeated). Note that the appearance determination parameter may decrease under certain conditions (e.g., when a boss round occurs). The appearance determination parameter may increase when a random-scenario game is played, but it is not limited to a random-scenario game and it may increase when another type of game (e.g., a scenario-specified game) is played.

In the present embodiment, the game system 1 calculates the appearance parameter so that the appearance parameter is larger as the appearance determination parameter of each player participating in the random-scenario game is larger. For example, the appearance parameter may be calculated as the sum of the appearance determination values of the players. As described above, in the present embodiment, the boss round is executed with a higher probability when the value of the appearance parameter is larger, so that the boss round is more likely to be executed when the value of the appearance determination parameter of each player is larger. Note that in other embodiments, the specific method of calculating the appearance parameter based on the appearance determination parameter is arbitrary.

For candidate weapon data, the game system 1 determines candidate weapons that can be used in the random-scenario game based on the current candidate data retrieved from the server 201 when the first start image is displayed.

For stage data, the game system 1 determines a game stage to be used in the random-scenario game based on the current stage data retrieved from the server 201 when displaying the first start image.

In the random-scenario game, a scenario is determined based on the scenario data generated as described above, and the random-scenario game is started with the determined scenario. As described above, in a random-scenario game, the random number seed is set so that the random number seed is not the same each time, so the elements of the scenario that are determined based on the random number seed (e.g., the occurrence of round events, the occurrence of boss rounds, and water levels) randomly change for every random-scenario game.

In the random-scenario game, some of the elements of the scenario are determined based on information associated with the players participating in the game (i.e., the skill levels and the appearance determination parameters). Specifically, information regarding enemy characters and clear conditions are determined based on the difficulty level based on the skill levels of the players, and the occurrence of boss rounds is determined based on appearance parameters based on the appearance determination parameters of the players. Therefore, these elements will vary depending on the players participating.

In the random-scenario game, some of the elements of the scenario are determined based on the time of execution of the game. Specifically, the game stage and candidate weapons are determined based on the time of execution of the game, and will change in accordance with the time of execution of the game.

When the random-scenario game ends, the information processing system saves the scenario data of the random-scenario game. In the present embodiment, the server 201 stores the game result data indicating the result of the random-scenario game and the scenario data in association with the player who played the random-scenario game. The game result data includes, for example, information indicating whether or not each round has been cleared, information indicating whether or not a round event and a boss round have occurred, and information indicating the weapon used by each player.

Note that server 201 stores the scenario data of the random-scenario game regardless of whether the random-scenario game has been cleared by the player. For a single player, the server 201 is not required to store game result data and scenario data for all games played by the player, but may store game result data and scenario data for a predetermined number (e.g., 50) of games, starting with the newest one. In other embodiments, game result data and scenario data may be stored in each game system.

While a case where players participating in the random-scenario game are determined by matching by the server 201 has been described above, when the game systems communicate with each other through local communication as described above, the players of the game systems communicating with each other through local communication may be determined to be player to participate in the random-scenario game. In this case, after the random-scenario game ends, the game result data and the scenario data are stored in each game system. Then, when the game system communicates with the server 201 thereafter, the result information and the scenario data are sent to and stored in the server 201.

[3-4. Retrieving Scenario Data]

In the present embodiment, the game system 1 can retrieve the scenario data stored in the server 201 as described above (step S3 shown in FIG. 10), and can play the scenario-specified game to be described below based on the retrieved scenario data (step S4 shown in FIG. 10).

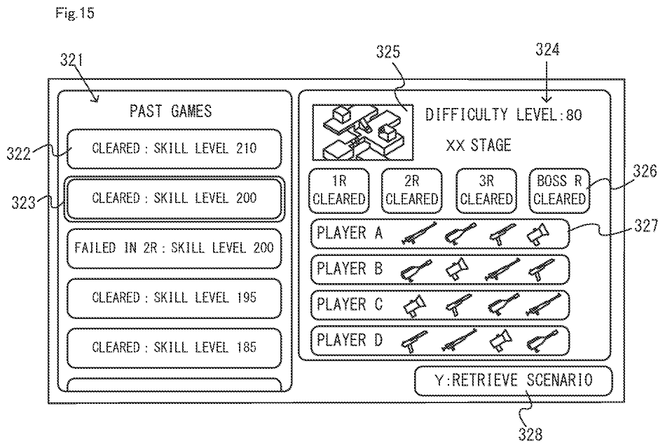

FIG. 15 is a diagram showing an example of a game image displayed to retrieve scenario data (referred to as the scenario retrieval image). The scenario retrieval image is displayed on the display 12, for example, in response to an instruction given by a player on a predetermined menu screen to view past game results.

As shown in FIG. 15, the scenario retrieval image includes a list display area 321 that shows a list of past games played by the player of the game system 1. The list display area 321 includes an outline image (e.g., an outline image 322 shown in FIG. 15) showing the outline of each game. The outline image may be any information indicating the outline of the game. In the example shown in FIG. 15, the outline image includes information indicating the game clearing result (specifically, whether the game has been cleared through the third round and, if the game has not been cleared through the third round, the round in which the player failed), and information indicating the player's skill level after the game. Note that in the example shown in FIG. 15, the list display area 321 is scrollable up and down, and the player can view more outline images by scrolling the list display area 321. The list display area 321 does not need to include outline images for all games the player has played in the past, but may include outline images for a predetermined number of newest games (e.g., 50).

In the scenario retrieval image, one of the outline images included in the list display area 321 is specified by the cursor 323 operated by the player. Here, the scenario retrieval image includes a detail display area 324 in which detailed information of the game indicated by the specified outline image is displayed. The detail display area 324 includes, for example, information indicating the difficulty level of the game (80 in FIG. 15), a stage image 325, a clear result image (e.g., a clear result image 326 shown in FIG. 15), and a used weapon image (e.g., a used weapon image 327 shown in FIG. 15). The stage image 325 shows the game stage used in the game. The clear result image indicates whether or not each round has been cleared in the game. The used weapon image indicates weapons used by the player characters in each round in the game. The detail display area 324 allows the player to check the details of the game indicated by the outline image. Note that the contents of the information shown in the detail display area 324 are arbitrary, and in addition to (or instead of) the information shown in FIG. 15, information indicating the player's score and rewards earned may be displayed.

The scenario retrieval image includes a retrieval instruction image 328 indicating a retrieval instruction to retrieve the scenario data to the game system 1. In the present embodiment, the player may give the retrieval instruction by pressing the Y-button 56 of the right controller 4, and the retrieval instruction image 328 prompts to press the Y-button 56. If the retrieval instruction is given by the player while the cursor 323 is specifying one outline image, the game system 1 executes the process to retrieve the scenario retrieval data of the game indicated by the outline image. Specifically, in the above case, the game system 1 transmits a scenario retrieval request to the server 201 to retrieve the scenario data. The server 201 transmits the scenario data of the game to the game system 1 in response to the scenario retrieval request. Thus, the game system 1 can retrieve the scenario data.

Note that in the present embodiment, the outline images included in the scenario retrieval image relate to previous games that have been played by the player of the game system 1. Note that the outline image may only be related to random-scenario games, or it may be related to another type of games (e.g., scenario-specified games) other than the random-scenario games. In the present embodiment, the player can retrieve scenario data related to games that the player himself/herself has played in the past by means of the retrieval instruction on the scenario retrieval image.

In the present embodiment, in addition to retrieving scenario data related to games that have been played by the player himself/herself, the player can also retrieve scenario data related to games that have been played by other players. An example of a process for retrieving scenario data related to games that have been played by other players will now be described.

In the present embodiment, the game system 1 displays a list of scenario data (which can be said to be games associated with the scenario data) stored on the server for the player of the game system 1 at a predetermined scene during execution of the game program, and accepts an input of an issuance instruction to issue a code for the specified scenario data in the list. For example, the game system 1 may display the scenario retrieval image described above as the list of scenario data, and accept the input of an issuance instruction at the scene where the scenario retrieval image is displayed. In response to the issuance instruction, the game system 1 transmits an issuance request to the server 201 to issue a code for the scenario data specified by the player. The server 201 generates and transmits a code corresponding to the scenario data to the game system 1 in response to the issuance request. At this time, the server 201 stores the generated code in association with the scenario data. The game system 1 displays the code received from the server 201 on the display 12. As described above, the player can retrieve the code for the scenario data related to the game that has been played the player himself/herself.

In the present embodiment, the player can input a code generated as described above so as to retrieve the scenario data corresponding to the code. Specifically, the game system 1 accepts a code input at a predetermined scene during execution of the game program and transmits information of the code input by the player to the server 201. Upon receiving the information of the code, the server 201 transmits the scenario data stored in association with the received code to the game system 1. Thus, the game system 1 can retrieve the scenario data corresponding to the code input by the player.

Note that in the present embodiment, not only when a code of scenario data related to a game that has been played by the player himself/herself is input, but also when a code of scenario data related to a game that has been played by another player is input, the game system 1 can retrieve scenario data corresponding to such a code. Thus, the player can obtain a code of scenario data related to a game that has been played by another player (e.g., the player being informed by the other player of the code) and input this code on the game system of the player himself/herself, thereby obtaining scenario data related to the game that has been played by the other player.

Note that the method for retrieving scenario data related to a game that has been played by another player is not limited to the method described above. For example, in other embodiments, the scenario retrieval image (FIG. 15) displayed by the game system may include an outline image for a game that has been played by another player who is different from the player of the game system. Note that the information regarding the outline image and the corresponding detail image is retrieved from the server 201 from the game system 1. Then, the player may be allowed to give a retrieval instruction by specifying the outline image for the game that has been played by the other player, thereby retrieving the scenario data of the game.

As described above, in the present embodiment, the game system 1 retrieves scenario data stored for a game that has been played by the player based on an operation input by the player, and retrieves scenario data stored for a game that has been played by another player different from that player based on an operation input by the player. Thus, the player can also retrieve scenario data for a game that has been played by another player, and can play the game (i.e., the scenario-specified game to be described below) based on the scenario data. A player can inform another player of a code of scenario data related to a game that has been played by the player himself/herself so that the other player can play a game of the same scenario as the game that has been played by the player himself/herself. For example, when there are multiple groups of players participating in the game, the multiple groups can play the game of the same scenario by sharing the same code among the groups. Note that in other embodiments, the game system 1 may be able to retrieve only one of the scenario data related to a game that has been played by the player and the scenario data related to a game that has been played by another player.

[3-5. Scenario-Specified Game]

In the present embodiment, the game system 1 is capable of executing a scenario-specified game based on scenario data retrieved as described above. The scenario-specified game will now be described.

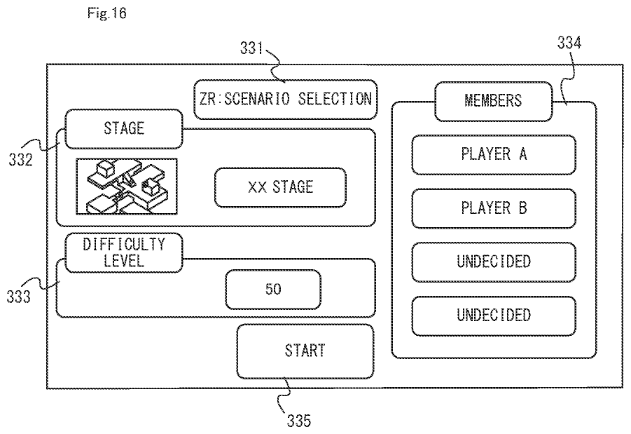

FIG. 16 is a diagram showing an example of a game image (called a second start image) displayed at the start of a scenario-specified game. In a scene where an instruction to specify the type of the game played by the player is accepted, for example, the second start image is displayed on the display 12 in response to an instruction to specify a scenario-specified game.

As shown in FIG. 16, the second start image includes a display instruction image 331 for giving an instruction to display a scenario selection image for selecting scenario data. In the present embodiment, the player can give the instruction by pressing the ZR-button 61 of the right controller 4, and the display instruction image 331 prompts to press the ZR-button 61. If the instruction is given by the player while the second start image is displayed, the game system 1 displays the scenario selection image on the display 12 instead of the second start image.

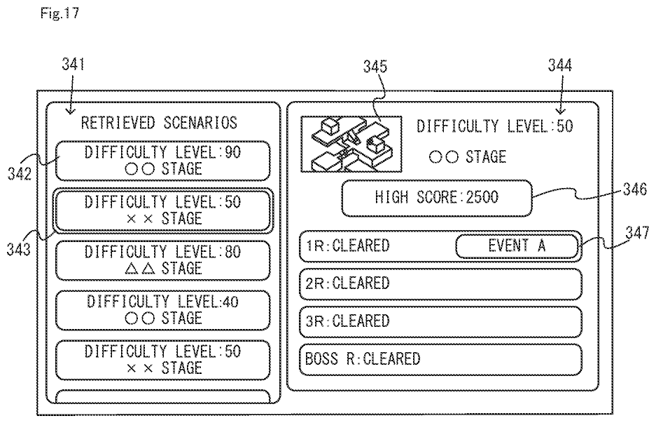

FIG. 17 is a diagram showing an example of a scenario selection image. The scenario selection image includes a list display area 341 that shows a list of scenario data retrieval in the game system 1. The list display area 341 includes a scenario image (e.g., a scenario image 342 shown in FIG. 17) showing scenario data corresponding to one iteration of the game. The scenario image may indicate any information indicating the outline of the scenario (which can be said to be an outline of the game corresponding to the scenario). In the example shown in FIG. 17, the scenario image includes information of the difficulty level in the scenario and information of the game stage. Note that the scenario image may also include information indicating candidate weapons that can be used by the player character, information indicating whether or not a round event occurs, and information indicating whether or not a boss round occurs. Note that in the example shown in FIG. 17, the list display area 341 can be scrolled up and down, and the player can view more scenario images by scrolling the list display area 341.

In the scenario selection image, one of the scenario images included in the list display area 341 is specified by a cursor 343 controlled by the player. Here, the scenario selection image includes a detail display area 344 in which detailed information of the scenario indicated by the specified scenario image is displayed. The detail display area 344 includes, for example, information indicating the difficulty level of the scenario (50 in FIG. 17), a stage image 345, a high score image 346, and a round image (for example, a round image 347 shown in FIG. 17). The stage image 325 indicates the game stage of the scenario. The high score image 346 indicates the high score so far for the game of the scenario. The round image indicates information regarding each round of the scenario. In the example shown in FIG. 17, the round image indicates the presence/absence and the type of the round event that occurs in the round (“Event A” shown in FIG. 17), and also indicates the game result of the round when the game of the scenario was played in the past. Thus, the player can select a scenario with reference to the contents of the detail display area 344.

Note that the contents of the scenario selection image are arbitrary, and in other embodiments, the scenario selection image may include, in addition to (or instead of) the information described above, information indicating candidate weapons that can be used by the player character, etc.

Where one scenario image is specified by the cursor 343 in the scenario selection image, when a selection instruction is given by the player (e.g., the player performs a predetermined determination operation), the game system 1 selects a scenario indicated by the scenario image, and displays a second start image indicating the selected scenario instead of the scenario selection image. Returning back to FIG. 16, the second start image includes a stage image 332 and a difficulty level image 333. The stage image 332 indicates the game stage of the selected scenario. The difficulty level image 333 indicates the difficulty level of the selected scenario. Note that in other embodiments, the second start image may indicate other elements (e.g., the presence/absence of round events, boss rounds, etc.) of the selected scenario.

As shown in FIG. 16, the second start image includes a participating player image 334. The participating player image indicates each player participating in the scenario-specified game. For example, the participating player image 334 has four frames in accordance with the number of players participating in the scenario-specified game, with the names of the players (“Player A” and “Player B” in FIG. 17) displayed in the frames of the players who have been decided to participate, and “undecided” is displayed in the frames of the players who have not been decided to participate.

Note that the method of determining players to participate in the scenario-specified game may be the same as or different from the random-scenario game described above. For example, for a scenario-specified game, participating players may be determined from among players who are pre-registered (e.g., players registered as friends) with the player of the game system 1, whereas for a random-scenario game, participating players may be determined regardless of whether they are such registered players.

The second start image includes a start instruction image 335. The start instruction image 335 is an image for giving a start instruction by the player to start the scenario-specified game. That is, the player gives a start instruction by performing a predetermined determination operation when the start instruction image 335 is specified (e.g., when the cursor, not shown, is specifying the start instruction image 335), and the scenario-specified game is started in response to the start instruction. Note that in the present embodiment, it is assumed that the same second start image as that described above is displayed also in game systems of players participating in the scenario-specified game. The scenario-specified game may be started in response to one of the players giving the start instruction, or it may be started in response to all of the players giving the start instruction.

When starting a scenario-specified game, the game system 1 starts the game based on the selected scenario (i.e., using scenario data indicating the selected scenario). The game process for executing the game based on the scenario data in a scenario-specified game is the same as the game process in a random-scenario game.

Here, the scenario data used in the scenario-specified game is generated during execution of the random-scenario game, and the same scenario data is used in the scenario-specified game and in the random-scenario game. When a game based on the same scenario data is played multiple times, the random number sequence is the same because the random number seed is of the same value, and other data used with the seed data (specifically, difficulty level data, appearance parameter data, and candidate weapon data) are also the same, so the elements of the scenario are determined to be of the same contents. That is, the scenario in the scenario-specified game is the same as the scenario in the random-scenario game from which the scenario data used in the scenario-specified game originated. Therefore, by retrieving the scenario data in the random-scenario game and playing the scenario-specified game based on the scenario data, the player can play the game again with the scenario of the random-scenario game.

Note that in the present embodiment, the scenario data includes information based on the participating players in the original random-scenario game (specifically, the difficulty level based on the skill level of each player). In the scenario-specified game, the above information is determined based on the selected scenario data and determined irrespective of the skill levels for the players participating in the scenario-specified game. Thus, in the present embodiment, a player may be able to play a scenario-specified game with a scenario (specifically, a difficulty level) that the player cannot experience when playing a random-scenario game.

As described above, in the present embodiment, the scenario data (specifically, the difficulty level data included in the scenario data) is generated based on player information that is associated with each player who participates in the random-scenario game and that is player information (specifically, the skill level) based on the previous game play of the player. Game events that are determined to occur in a scenario-specified game based on scenario data (e.g., events in which enemy characters appear that are determined to occur based on difficulty level data) are determined independently of the player information associated with players who participate in the scenario-specified game. Thus, a player can play a scenario-specified game with a scenario that the player cannot experience when playing a random-scenario game.

In the present embodiment, the scenario data includes information on the game stages and the candidate weapons in the original random-scenario game. In a scenario-specified game, the game stage and the candidate weapons are determined based on the selected scenario data, and are determined irrespective of the game stage and the candidate weapons that are applied at the time of execution of the scenario-specified game (i.e., the game stage and the candidate weapons used when the random-scenario game is played at that point in time). Thus, in the present embodiment, a player may play a scenario-specified game using a game stage and candidate weapons that are not applicable when playing a random-scenario game at that point in time by means of a scenario-specified game.

In the present embodiment, the scenario data retrieved on the game system 1 is not deleted by executing a scenario-specified game (note that it may be deleted in response to a deletion instruction by a player). Therefore, the player can repeatedly play a scenario-specified game using one scenario data. Thus, the player can repeatedly play a game with a desired scenario by retrieving scenario data of a favorite scenario.

In the present embodiment, as described above, the scenario data of the random-scenario game is saved regardless of whether the random-scenario game has been cleared by the player. Therefore, even if the player fails to clear the random-scenario game, the player can substantially retry the random-scenario game that the player failed to clear by playing a scenario-specified game based on the scenario data of the random-scenario game.

In the present embodiment, when a scenario-specified game ends, the server stores the result information indicating the result of the scenario-specified game and the scenario data in association with the player who played the scenario-specified game, as when a random-scenario game ends. Therefore, even for a player of a game system that has not retrieved the scenario data used in the scenario-specified game at the start of a scenario-specified game, from among players who have participated in the scenario-specified game, the server will store the scenario data in association with the player. Thus, after the scenario-specified game ends, the player can retrieve the scenario data on the scenario retrieval image and play the game with the same scenario as the scenario in the scenario-specified game.

[4. Specific Example of Process on Information Processing System]

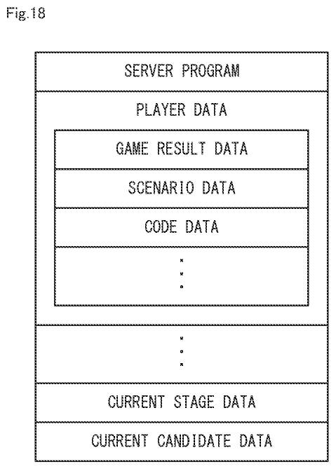

Next, with reference to FIG. 18 to FIG. 23, specific examples of information processes performed on the information processing system will be described.

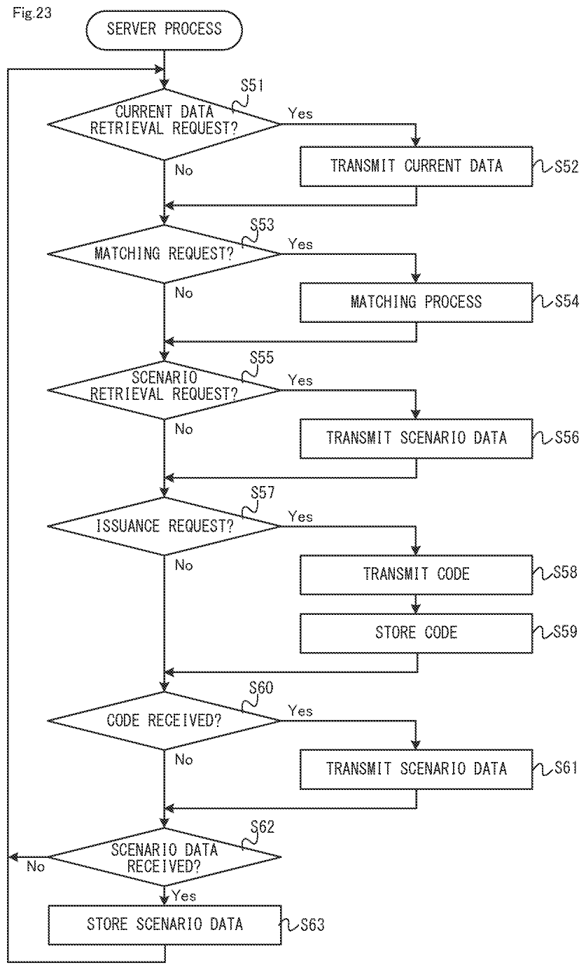

FIG. 18 is a diagram showing an example of various seed data stored in the server 201 in the information processing system. As shown in FIG. 18, the server 201 stores a server program. The server program is a server-side information processing program for executing the game on the game system 1, and is a program for executing the information processes (i.e., the processes shown in FIG. 23) executed on the server 201. That is, the processes to be described below (see FIG. 23) are executed on the server 201 by the processing section 211 of the server 201 executing the server program.

The server 201 stores player data regarding the players of the game systems that execute the game in the storage section 212. In the present embodiment, the player data includes game result data, scenario data, and code data. The server 201 stores the player data for each player.

The game result data indicates the game results of the game played by the player. The scenario data indicates information for identifying the scenario of the game played by the player, as described above (see FIG. 12). The game result data and scenario data are stored for each game. However, if the game is played multiple times based on the same scenario data, the server 201 may only store one scenario data.

The code data indicates a code to be issued for scenario data, as needed. As described above, when a code is issued for scenario data in response to an issuance instruction by the player, code data indicating the code is stored on server 201 in association with the scenario data.

The server 201 stores the current stage data and the current candidate data described above in the storage section 212. The contents of the current stage data and the current candidate data are updated, for example, each time a predetermined amount of time elapses.

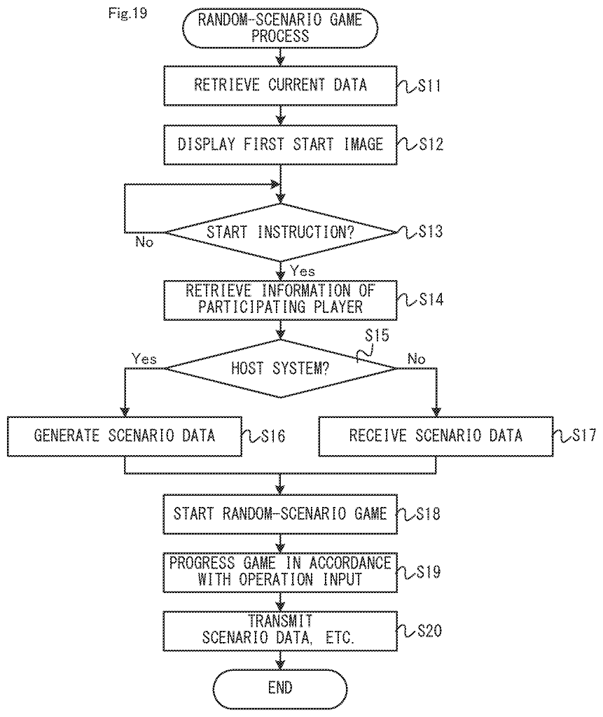

Note that although not shown in the figures, the game system 1 stores a game program for executing the game. The game program is an information processing program on the terminal side for executing the game, and is a program for executing the game process (the processes shown in FIG. 19 to FIG. 22) executed on the game system 1. That is, by the processor 81 of the game system 1 executing the game program, the processes to be described below (see FIG. 19 to FIG. 22) are executed on the game system 1.

The game system 1 stores various data used for executing the game, such as data related to characters, e.g., player characters and enemy characters, and data related to weapons. Note that the game system 1 may store some or all of the seed data (see FIG. 18) stored in the server 201 for use in executing the game. Each data used in the information processing system may be stored on either the server 201 or the game system 1. Note that when the same data is stored on the server 201 and the game system 1, the data stored on the server 201 and the data stored on the game system 1 are synchronized at appropriate points in time.

Next, with reference to FIG. 19 to FIG. 23, specific examples of information processes executed by the game system 1 or the server 201 will be described.

Note that the present embodiment is described assuming that the processor 81 of the main body apparatus 2 executes the processes of the steps shown in FIG. 19 to FIG. 22 by executing the game program stored in the game system 1. It is described also assuming that the processor of the server 201 (i.e., the processing section 211) executes the processes of the steps shown in FIG. 23 by executing the server program stored in the server 201. Note however that in other embodiments, some of the processes of the steps described above may be executed by another processor (e.g., a dedicated circuit) different from the processor. Some of the processes of the steps executed on the game system 1 may be executed on the server 201, and some of the processes of the steps executed on the server 201 may be executed on the game system 1. In that case, programs for executing the processes may be stored distributed between storage media of a plurality of devices (e.g., the main body apparatus 2 and the server 201). The processes of the steps shown in FIG. 19 to FIG. 23 are merely illustrative, and the order of steps to be performed may be switched around or other processes may be executed in addition to (or instead of) the processes of the steps, as long as similar results are obtained.

The processor of the game system 1 or the server 201 executes the processes of the steps shown in FIG. 19 to FIG. 23 using a memory (e.g., the DRAM 85). That is, the processor stores information (in other words, data) obtained in each process step in the memory, and when the information is used in a subsequent process step, the information is read out from the memory and used.

FIG. 19 is a flow chart showing an example of a flow of a random-scenario game process executed by the game system 1. Note that the random-scenario game process shown in FIG. 19 is started, for example, in response to an instruction to specify a random-scenario game being given during execution of the game program at a scene where an instruction to specify the type of game to be played by the player is accepted.

In step S11 shown in FIG. 19, the processor 81 retrieves from the server 201 the current stage data indicating the stage currently applicable in the random-scenario game and the current candidate data indicating the candidate weapons currently applicable. Specifically, the processor 81 transmits to the server 201 a current data retrieval request to retrieve the current stage data and the current candidate data using the network communication section 82. As described in detail below, the server 201 transmits the current stage data and the current candidate data to the game system in response to receiving the current data retrieval request from the game system. The processor 81 receives the current stage data and the current candidate data transmitted from the server 201 using the network communication section 82. The process of step S12 is executed, following step S11.

In step S12, the processor 81 displays on the display 12 the first start image described above (see FIG. 14) for starting the random-scenario game. At this time, the contents of the stage image and the candidate weapon image included in the first start image are determined based on the current stage data and the current candidate data retrieved in step S11. Note that in the process examples shown in FIG. 19 to FIG. 22, the image generated by the game system 1 is displayed on the display 12, but the image may be displayed on another display device (e.g., a stationary monitor as described above) that is accessible by the game system 1. The process of step S13 is executed, following step S12.

In step S13, the processor 81 determines whether the player has given a start instruction to start the random-scenario game. Note that the processor 81 retrieves the operation data received from the controllers via the controller communication section 83 and/or the terminals 17 and 21 at an appropriate timing. Based on the retrieved operation data, the processor 81 determines whether various instructions have been given by the player. If the determination result from step S13 is positive, the process of step S14 is executed. On the other hand, if the determination result from step S13 is negative, the process of step S13 is executed again. That is, the processor 81 waits while the first start image is displayed until a start instruction is given.

In step S14, the processor 81 retrieves information on the players participating in the random-scenario game. Specifically, the processor 81 transmits a matching request for matching participating players to the server 201 using the network communication section 82. As described in detail below, the server 201 determines the participating players in response to receiving a matching request from a game system, and transmits information of the participating players to the game system. The processor 81 receives information on the participating players transmitted from the server 201 using the network communication section 82. Note that the information of the participating players includes information for communicating with the game systems of the players, information indicating the game system that serves as the host system, and information of the player character of each player. The received participating player information enables communication between the game systems of the players participating in the random-scenario game and also enables execution of the random-scenario game in which the players participate. The process of step S15 is executed, following step S14.

In step S15, the processor 81 determines whether the player's system is the host system based on the information retrieved in step S14. If the determination result from step S15 is positive, the process of step S16 is executed. On the other hand, if the determination result from step S15 is negative, the process of step S17 is executed.

In step 516, the processor 81 generates scenario data to be used in the random-scenario game. That is, the processor 81 generates scenario data by the method described in “[3-3. Random-scenario game]” above. The processor 81 transmits the generated scenario data to game systems of other players participating in the random-scenario game by using the network communication section 82. The process of step S18 is executed, following step S16.

On the other hand, in step S17, the processor 81 receives, using the network communication section 82, scenario data transmitted from the game system to be the host system by the process of step S16 executed by the game system to be the host system. The process of step S18 is executed, following step S17.

In step S18, the processor 81 starts the random-scenario game. That is, the processor 81 starts executing the random-scenario game based on the scenario data generated in the process of step S16 or received in the process of step S17. The process of step S19 is executed, following step S18.

In step S19, the processor 81 progresses the random-scenario game based on operation inputs by the participating players. Specifically, the processor 81 retrieves operation data of the player of the host system from the controllers, and retrieves operation data of the other players by receiving the operation data from other game systems using the network communication section 82. The processor 81 progresses the random-scenario game based on these retrieved operation data. Note that the processor 81 may refer to the scenario data at an appropriate timing during the game and execute processes based on the scenario data (e.g., processes to generate game events). The processor 81 continues to perform the process of step S19 until the random-scenario game ends, and executes the process of step S20 after the random-scenario game ends.

In step S20, the processor 81 transmits the game result data and the scenario data regarding the random-scenario game executed in steps S18 and S19 to the server 201. That is, the processor 81 generates the game result data based on the results of the random-scenario game and transmits the scenario data used for the random-scenario game and the game result data to the server 201 using the network communication section 82. After step S20, the processor 81 ends the random-scenario game process shown in FIG. 19.

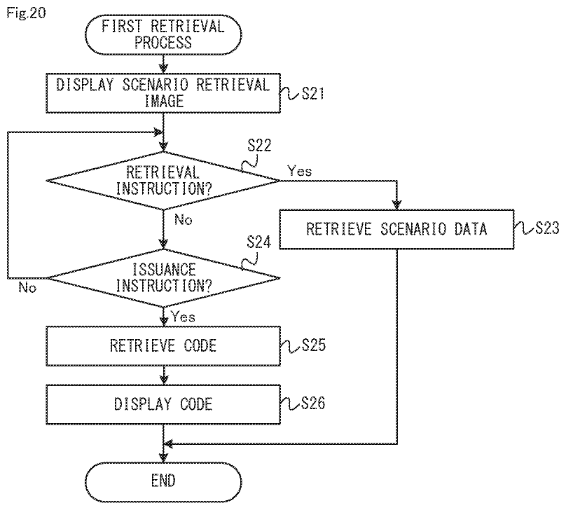

FIG. 20 is a flow chart showing an example of a flow of the first retrieval process executed by the game system 1. The first retrieval process is a process for retrieving scenario data of the game played by the player himself/herself from the server 201. Note that the first retrieval process shown in FIG. 20 is started during execution of the game program, for example, in response to an instruction to view past game results on a predetermined menu screen.

In step S21, the processor 81 displays the scenario retrieval image (see FIG. 15) described above on the display 12. Note that the information used to generate the scenario retrieval image (e.g., game result data) may be stored in the game system 1 or may be stored in the server 201. If the information is stored in the server 201, the processor 81 retrieves the information from the server 201 to generate the scenario retrieval image. Note that although not shown in the figures, while displaying the scenario retrieval image, the processor 81 switches a specified one of the outline images included in the scenario retrieval image in response to an operation input by the player. The process of step S22 is executed, following step S21.

In step S22, the processor 81 determines whether the retrieval instruction for retrieving the scenario data corresponding to the outline image specified on the scenario retrieval image has been given by the player. If the determination result from step S22 is positive, the process of step S23 is executed. On the other hand, if the determination result from step S22 is negative, the process of step S24 is executed.

In step S23, the processor 81 retrieves the scenario data for the retrieval instruction from the server 201. First, the processor 81 transmits a scenario retrieval request for retrieving the scenario data to the server 201 using the network communication section 82. As described in detail below, the server 201 transmits the scenario data corresponding to the scenario retrieval request to the game system in response to receiving the scenario retrieval request from the game system. The processor 81 receives the scenario data transmitted from the server 201 using the network communication section 82. The processor 81 stores the received scenario data in a storage section (e.g., an internal storage medium such as the flash memory 84 or an external storage medium attached to the slot 23). After step S23, the processor 81 ends the first retrieval process.

In step S24, the processor 81 determines whether the issuance instruction for issuing the code for the scenario data corresponding to the outline image specified on the scenario retrieval image has been given by the player. If the determination result from step S24 is positive, the process of step S25 is executed. On the other hand, if the determination result from step S24 is negative, the process of step S22 is executed again. That is, the processor 81 waits while the scenario retrieval image is displayed until a retrieval instruction or an issuance instruction is given.

In step S25, the processor 81 retrieves the code for the issuance instruction from the server 201. First, the processor 81 transmits a request for issuance of the code to the server 201 using the network communication section 82. As described in detail below, the server 201, in response to receiving the issuance request from the game system, transmits information of the code corresponding to the issuance request to the game system. The processor 81 receives the information of the code transmitted from the server 201 using the network communication section 82. The process of step S26 is executed, following step S25.

In step S26, the processor 81 displays the code received in step S25 on the display 12. Thus, the player can obtain the code for the scenario data. After step S26, the processor 81 ends the first retrieval process.

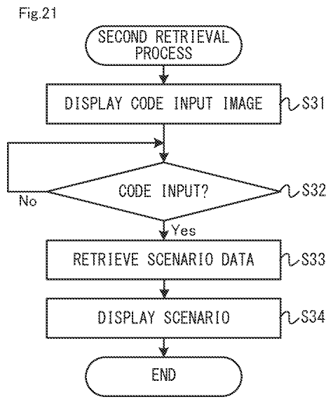

FIG. 21 is a flow chart showing an example of a flow of the second retrieval process executed by the game system 1. The second retrieval process is a process for retrieving scenario data of a game played by a player different from the player of the game system 1 from the server 201. Note that the second retrieval process shown in FIG. 21 is started in response to an instruction to input a code on the predetermined menu screen being given by the player, for example, during execution of the game program.

In step S31, the processor 81 displays, on the display 12, a code input image for accepting an entry of a code from the player. The process of step S32 is executed, following step S31.

In step S32, the processor 81 determines whether the code has been input by the player on the code input image. If the determination result from step S32 is positive, the process of step S33 is executed. On the other hand, if the determination result from step S32 is negative, the process of step S32 is executed again. That is, the processor 81 waits while the code input image is displayed until the code is input.

In step S33, the processor 81 retrieves the scenario data associated with the code input in step S32 from the server 201. First, the processor 81 transmits the information of the input code to the server 201 using the network communication section 82. As described in detail below, in response to receiving information of the code from the game system, the server 201 transmits the scenario data associated with the code to the game system. The processor 81 receives the scenario data transmitted from the server 201 using the network communication section 82. The processor 81 stores the received scenario data in a storage section (e.g., an internal storage medium such as the flash memory 84 or an external storage medium attached to the slot 23). The process of step S34 is executed, following step S33.

In step S34, the processor 81 displays the contents of the scenario indicated by the scenario data received in step S33 on the display 12. As the contents of the scenario, the processor 81 displays information such as the game stage, the candidate weapon and the difficulty level, for example. This allows the player to check the contents of the scenario data. After step S34, the processor 81 ends the second retrieval process.

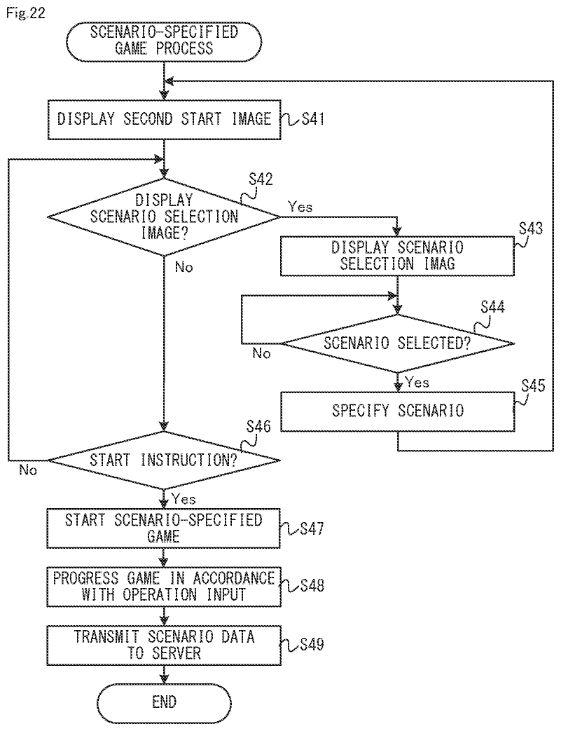

FIG. 22 is a flow chart showing an example of a flow of the scenario-specified game process executed by the game system 1. Note that the scenario-specified game process shown in FIG. 22 is started, for example, in response to an instruction to specify a scenario-specified game being given at a scene where the player receives an instruction to specify the type of game to be played during the execution of the game program.

In step S41, the processor 81 displays, on the display 12, the second start image (see FIG. 16) to start the scenario-specified game. Note that if the process of step S41 is executed after the scenario is selected by the processes of steps S44 and S45 described below, the stage image and the difficulty level image included in the second start image are updated so as to indicate the stage and the difficulty level of the selected scenario. On the other hand, if the process of step S41 is executed before the scenario is selected by the processes of steps S44 and S45 described below, the stage image and the difficulty level image may be displayed as blank. In such a case, the stage image and the difficulty level image may be displayed so as to indicate the stage and the difficulty level in a predetermined scenario (e.g., the scenario of the previous scenario-specified game). The process of step S42 is executed, following step S41.

Note that although not shown in the figures, after the scenario-specified game process is started, the processor 81 sends the matching request to the server 201 and also accepts, from the server 201 or another game system, information of another player participating in the scenario-specified game. When the information of the other player is received, the processor 81 updates the participating player image in the second start image so as to include information of this player.

In step S42, the processor 81 determines whether the player has given an instruction to display the scenario selection image (see FIG. 17) described above for selecting scenario data. If the determination result from step S42 is positive, the process of step S43 is executed. On the other hand, if the determination result from step S42 is negative, the process of step S46 is executed.

In step S43, the processor 81 displays the scenario selection image on the display 12. That is, the processor 81 generates and displays a scenario selection image based on the scenario data that has been retrieved in the game system 1 by the first retrieval process or the second retrieval process. Note that although not shown in the figure, while the scenario selection image is being displayed, the processor 81 switches the specified one of the scenario images included in the scenario selection image in response to an operation input by the player. The process of step S44 is executed, following step S43.

In step S44, the processor 81 determines whether the player has given the selection instruction to select one of the scenarios (i.e., scenario images) shown in the scenario selection image. If the determination result from step S44 is positive, the process of step S45 is executed. On the other hand, if the determination result from step S44 is negative, the process of step S44 is executed again. That is, the processor 81 waits while the scenario selection image is displayed until the selection instruction is given.

In step S45, the processor 81 identifies the scenario related to the selection instruction given in step S44 and executes the process of step S41 again. As a result, in step S41 to be executed next, the second start image indicating the stage and the difficulty level of the scenario identified in step S45 is displayed.

On the other hand, in step S46, the processor 81 determines whether the player has given a start instruction to start the scenario-specified game in a state in which the scenario-specified game can be started. Note that the “state in which the scenario-specified game can be started” refers to the state in which the scenario of the scenario-specified game has been selected and the players to participate in the scenario-specified game have been decided. If the determination result from step S46 is positive, the process of step S47 is executed. On the other hand, if the determination result from step S46 is negative, the process of step S42 is executed again. That is, the processor 81 waits while the second start image or the scenario selection image is displayed until the start instruction is given.

In step S47, the processor 81 starts the scenario-specified game. That is, the processor 81 reads out the scenario data related to the scenario selected in step S44, and starts executing the scenario-specified game based on the scenario data. The process of step S48 is executed, following step S47.

In step S48, the processor 81 progresses the random-scenario game based on operation inputs by the participating players. The process of step S48 may be similar to the process of step S19 in the random-scenario game process. The processor 81 continues to perform the process of step S48 until the scenario-specified game ends, and executes the process of step S48 after the scenario-specified game ends.

In step S49, the processor 81 transmits, to the server 201, game result data and scenario data related to the scenario-specified game executed in steps S47 and S48. That is, the processor 81 generates game result data based on the results of the scenario-specified game, and transmits the scenario data used for the scenario-specified game and the game result data to the server 201 using the network communication section 82. After step S49, the processor 81 ends the scenario-specified game process shown in FIG. 22.

FIG. 23 is a flow chart showing an example of a flow of the server process executed by the server 201. Note that the series of processes shown in FIG. 23 is continuously executed while the server 201 is in operation.

In step S51 shown in FIG. 23, the processing section 211 determines whether the current data retrieval request (see step S11 shown in FIG. 19) has been received from the game system via the communication section 213. If the determination result from step S51 is positive, the process of step S52 is executed. On the other hand, if the determination result from step S51 is negative, the process of step S53 is executed, skipping the process of step S52.

In step S52, the processing section 211 transmits the current stage data and the current candidate data to the game system. That is, the processing section 211 transmits the current stage data and the current candidate data stored in the storage section 212 using the communication section 213 to the game system which has transmitted the current data retrieval request. The process of step S53 is executed, following step S52.

In step S53, the processing section 211 determines whether the matching request (see step S14 shown in FIG. 19) has been received from the game system via the communication section 213. If the determination result from step S53 is positive, the process of step S54 is executed. On the other hand, if the determination result from step S53 is negative, the process of step S55 is executed, skipping the process of step SM.

In step SM, the processing section 211 executes a matching process to match with players who have given the matching request for the random-scenario game. Note that the specific method of matching is arbitrary. The processing section 211 transmits the information of the participating players determined by the matching process to the game systems that have transmitted the matching request using the communication section 213. The process of step S55 is executed, following step SM.

In step S55, the processing section 211 determines whether the scenario retrieval request (see step S23 in FIG. 20) has been received from the game system via the communication section 213. If the determination result from step S55 is positive, the process of step S56 is executed. On the other hand, if the determination result from step S55 is negative, the process of step S57 is executed, skipping the process of step S56.

In step S56, the processing section 211 transmits the scenario data to game systems that have transmitted the scenario retrieval request. In the present embodiment, the scenario retrieval request includes identification information that can identify the player of the game system that has transmitted the scenario retrieval request, and specification information that can specify the scenario. The processing section 211 transmits, to the game system using the communication section 213, the scenario data specified by the specification information among the scenario data included in the player data stored in the storage section 212 for the player indicated by the identification information. The process of step S57 is executed, following step S56.

In step S57, the processing section 211 determines whether the issuance request (see step S25 in FIG. 20) has been received from the game system via the communication section 213. If the determination result from step S57 is positive, the process of step S58 is executed. On the other hand, if the determination result from step S57 is negative, the process of step S60 is executed, skipping the process of step S58.

In step S58, the processing section 211 transmits information of the code of the scenario data to the game system that has transmitted the issuance request. That is, the processing section 211 generates the code by any method and transmits the information of the generated code to the game system using the communication section 213. The process of step S59 is executed, following step S58.

In step S59, the processing section 211 stores the code generated in step S58 in association with the corresponding scenario data. In the present embodiment, the issuance request includes identification information that can identify the player of the game system that has transmitted the issuance request and specification information that can specify the scenario. The processing section 211 stores scenario data that is specified by the specification information from among scenario data included in the player data stored in the storage section 212 for the player who is identified by the identification information, while the scenario data is associated with the code data indicating the code generated in step S58. The process of step S60 is executed, following step S59.

In step S60, the processing section 211 determines whether information of the code transmitted from the game system (see step S33 shown in FIG. 21) has been received via the communication section 213. If the determination result from step S60 is positive, the process of step S61 is executed. On the other hand, if the determination result from step S60 is negative, the process of step S62 is executed, skipping the process of step S61.

In step S61, the processing section 211 transmits the scenario data corresponding to the code received in step S60 to the game system that has transmitted the information of the code. That is, the processing section 211 transmits the scenario data stored in association with the received code in the storage section 212 to the game system using the communication section 213. The process of step S62 is executed, following step S61.

In step S62, the processing section 211 determines whether the scenario data and the game result data (see step S20 in FIG. 19 and step S49 in FIG. 22) that are transmitted from the game system after the game of the game system ends have been received from the game system. If the determination result from step S62 is positive, the process of step S63 is executed. On the other hand, if the determination result from step S62 is negative, the process of step S51 is executed again, skipping the process of step S63.

In step S63, the processing section 211 stores the scenario data and the game result data received in step S62 in the storage section 212. Specifically, the processing section 211 updates the player data for the player of the game system that has transmitted the scenario data and the game result data, from among the player data stored in the storage section 212, so that the player data includes the scenario data and the game result data. The process of step S51 is executed again, following step S63. Thereafter, the processing section 211 repeatedly executes the processes of steps S51 to S63.

[5. Functions/Effects and Variations of Present Embodiment]

As described above, in the embodiment described above, the information processing system (specific example: the game system 1) is configured to include the following units (it can also be said that the game program, which is an example of the information processing program, is configured to cause a computer to function as the following units).
a first game start unit (step S8) that starts a game (specific example: the random-scenario game) in which at least one of game events to occur is randomly determined in response to a first instruction that is input by the player (specific example: the start instruction in the first start image);
a first game progressing unit (step S9) that progresses the game started in response to the first instruction based on an operation input by the player;
a unit (step S63) for storing scenario data at least including game event information related to a game event that has occurred in the game started in response to the first instruction;
a scenario data retrieval unit (step S23 or S33) that retrieves one of the stored scenario data that is specified based on an operation input by the player;
a second game start unit (step S47) that starts the game (specific example: the scenario-specified game) in which a game event to occur is determined based on the retrieved scenario data in response to a second instruction (specific example: the start instruction in the second start image) that is input by the player; and a second game progressing unit (step S48) that progresses the game started in response to the second instruction based on an operation input by the player.

According to the above, the player can play a game that is started in response to the second instruction with the same game settings (specifically, settings defined by the scenario data) as the game started in response to the first instruction. Thus, the player can play the game again with desired game settings. For example, since the player can repeatedly try a game with certain game settings, it can be said that the information processing system provides the player a chance to improve the skills to play the game. Since the player can repeatedly play a game with favorite game settings, it is possible to improve the gameplay of the game.

Note that the above embodiment has been described for a case where a multi-player game is executed in which a plurality of players participate. That is, in the embodiment described above, the information processing system starts a game in which a plurality of players including the player who has given the first instruction participate, and starts a game in which a plurality of players including the player who has given the second instruction. Thus, the player can play a game (specifically, a game started in response to the second instruction) with the same game settings as the game started in response to the first instruction, and with different participating players from the game started in response to the first instruction. Note that in other embodiments, the game started in response to the first instruction and/or the game started in response to the second instruction may be a game played by a single player.

In the embodiment described above, scenario data is generated before the start of the game started in response to the first instruction, and the scenario data is used in the game and also used in the game started in response to the second instruction. That is, in the embodiment described above, the scenario data is generated each time the first instruction is given so that a game event randomly occurs for each first instruction in the game. The information processing system starts a game based on the generated scenario data (specifically, the game started in response to the first instruction), and stores scenario data generated in response to the first instruction for the game. Thus, the game started in response to the first instruction and the game started in response to the second instruction can be played using the same scenario data, and it is therefore possible to easily perform the game process using the scenario data.

Note that in other embodiments, the timing at which scenario data is generated is not limited to the above, but it may be after the end of the game started in response to the first instruction. For example, in the game started in response to the first instruction, the information processing system may execute the game process using data that has different contents and/or format from the scenario data, and generate scenario data related to the game after the game ends.

Note that in the embodiment described above, where a process is executed using data (which is meant to include programs) on an information processing apparatus, a part of data necessary for the process may be transmitted from another information processing apparatus that is different from the information processing apparatus. Then, the first information processing apparatus may execute the process using data received from the second information processing apparatus and data stored in the first information processing apparatus.

Note that in other embodiments, the information processing system does not need to include some of the components of the embodiment described above and does not need to execute some of the processes that are executed in the embodiment described above. For example, in order to realize a specific one of the advantageous effects of the embodiment described above, the information processing system may include a component or components for realizing the specific advantageous effect and execute a process or processes for realizing the specific advantageous effect, and the information processing system does not need to include other components and does not need to execute other processes.

The embodiment described above can be used as, for example, a game system or a game program, with the aim of allowing the player to repeatedly play a game with desired game settings.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage medium having stored therein instructions that, when executed, cause one or more processors of an information processing apparatus to execute game processing comprising:
starting a game in which at least one of game events to occur is randomly determined in response to a first instruction that is input by a player;
progressing the game started in response to the first instruction based on an operation input by the player;
retrieving one of scenario data that is specified based on an operation input by the player, the scenario data at least including game event information related to a game event that has occurred in the game started in response to the first instruction;
starting the game in which a game event to occur is determined based on the retrieved scenario data in response to a second instruction that is input by the player; and
progressing the game started in response to the second instruction based on an operation input by the player.

2. The storage medium according to claim 1, wherein in retrieving the scenario data, the scenario data stored for the game started in response to the first instruction by the player is retrieved based on an operation input by the player, and the scenario data stored for the game started in response to the first instruction by another player different from the player is retrieved based on an operation input by the player.

3. The storage medium according to claim 1, wherein in retrieving the scenario data, the scenario data is retrieved based on an operation input by the player from among the scenario data stored in response to the first instruction irrespective of whether the game has been cleared by the player.

4. The storage medium according to claim 1, wherein the game event information includes information related to a timing at which the game event occurs in the game.

5. The storage medium according to claim 1, wherein the game event information includes information related to an enemy character to appear in the game event.

6. The storage medium according to claim 5, wherein the game event information includes information related to a timing at which the enemy character appears in the game event.

7. The storage medium according to claim 5, wherein the game event information includes information indicating a position at which the enemy character appears in a game stage in the game event.

8. The storage medium according to claim 1, wherein the game event information includes information indicating a game skill available to the player in the game.

9. The storage medium according to claim 8, wherein the game process further includes presenting, to the player, at a scene for giving the first instruction or a scene therebefore, a candidate of the game skill made available in the game started in response to the first instruction.

10. The storage medium according to claim 1, wherein the scenario data includes information indicating a type of a game stage, from among a plurality of types of game stages, that is used in the game.

11. The storage medium according to claim 10, wherein the game process further includes presenting, to the player, at a scene for giving the first instruction or a scene therebefore, a type of the game stage to be used in the game started in response to the first instruction.

12. The storage medium according to claim 1, wherein the game event information includes information related to a range of movement of a player character across the game stage used in the game.

13. The storage medium according to claim 1, wherein the scenario data includes information indicating a difficulty level of the game.

14. The storage medium according to claim 13, wherein the information indicating a difficulty level of the game included in the stored scenario data is determined based on a parameter indicating a skill level that is associated with at least one of players participating in the game related to the scenario data.

15. The storage medium according to claim 1, wherein:
a game in which a plurality of players including the player who has given the first instruction participate is started in response to the first instruction; and
a game in which a plurality of players including the player who has given the second instruction participate is started in response to the second instruction.

16. The storage medium according to claim 1, wherein:
the scenario data is generated each time the first instruction is given so that the game event randomly occurs in the game for each first instruction;
the game based on the generated scenario data is started in response to the first instruction; and
the scenario data generated in response to the first instruction is stored for the game started in response to the first instruction.

17. The storage medium according to claim 16, wherein:
the scenario data is generated based on player information that is associated with each player participating in the game started in response to the first instruction and that is based on previous game play of the player; and
the game event whose occurrence is determined based on the scenario data in the game started in response to the second instruction is determined independent of the player information associated with the players participating in the game.

18. An information processing system comprising at least one processor and a non-transitory computer-readable storage medium having stored therein instructions that, when executed, cause the information processing system to execute game processing comprising:
starting a game in which at least one of game events to occur is randomly determined in response to a first instruction that is input by a player;
progressing the game started in response to the first instruction based on an operation input by the player;
retrieving one of scenario data that is specified based on an operation input by the player, the scenario data at least including game event information related to a game event that has occurred in the game started in response to the first instruction;
starting the game in which a game event to occur is determined based on the retrieved scenario data in response to a second instruction that is input by the player; and
progressing the game started in response to the second instruction based on an operation input by the player.

19. An information processing apparatus comprising at least one processor and a non-transitory computer-readable storage medium having stored therein instructions that, when executed, cause the information processing apparatus to execute game processing comprising:
starting a game in which at least one of game events to occur is randomly determined in response to a first instruction that is input by a player;
progressing the game started in response to the first instruction based on an operation input by the player;
retrieving one of scenario data that is specified based on an operation input by the player, the scenario data at least including game event information related to a game event that has occurred in the game started in response to the first instruction;
starting the game in which a game event to occur is determined based on the retrieved scenario data in response to a second instruction that is input by the player; and
progressing the game started in response to the second instruction based on an operation input by the player.

20. An information processing method executed by an information processing system, the information processing system executing game processing comprising:
starting a game in which at least one of game events to occur is randomly determined in response to a first instruction that is input by a player;
progressing the game started in response to the first instruction based on an operation input by the player;
retrieving one of scenario data that is specified based on an operation input by the player, the scenario data at least including game event information related to a game event that has occurred in the game started in response to the first instruction;
starting the game in which a game event to occur is determined based on the retrieved scenario data in response to a second instruction that is input by the player; and
progressing the game started in response to the second instruction based on an operation input by the player.
